(19) United States
(12) Patent Application Publication
(10) Pub. No.: US 2026/0095869 A1
(43) Pub. Date: Apr. 2, 2026

(54) OPEN-LOOP POWER CONTROL PARAMETER DETERMINATION AT USER EQUIPMENT

(71) Applicant: QUALCOMM Incorporated, San Diego, CA (US)

(72) Inventors: Qing LI, Princeton Junction, NJ (US); Junyi LI, Greentown, PA (US)

(21) Appl. No.: 18/903,895

(22) Filed: Oct. 1, 2024

(51) Int. Cl. H04W 52/10; H04W 52/24; H04W 52/26

(52) U.S. Cl. CPC H04W 52/10; H04W 52/242; H04W 52/265

(57) ABSTRACT

Certain aspects of the present disclosure provide techniques for obtaining a set of input parameters associated with an open-loop power control (OLPC) parameter determination; and transmitting a communication using one or more OLPC parameters, wherein the one or more OLPC parameters are based on the set of input parameters and the OLPC parameter determination, and wherein the one or more OLPC parameters are associated with at least one of a quality of service or an energy allocation.

### INTRODUCTION

### Field of the Disclosure

Aspects of the present disclosure relate to wireless communications, and more particularly, to techniques for adjustable open-loop power control parameters.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining a set of input parameters associated with an open-loop power control (OLPC) parameter determination; and transmitting a communication using one or more OLPC parameters, wherein the one or more OLPC parameters are based on the set of input parameters and the OLPC parameter determination, and wherein the one or more OLPC parameters are associated with at least one of a quality of service or an energy allocation.

Certain aspects provide a method for wireless communications by a network entity. The method includes sending, to a UE, a first indication of at least one of: a range of selectable values for each of one or more OLPC parameters, or a set of selectable values for each of the one or more OLPC parameters; and obtaining, from the UE, a communication associated with the one or more OLPC parameters, wherein the one or more OLPC parameters are based on the range of selectable values or the set of selectable values.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram illustrating an example of open-loop power control (OLPC).

FIG. 6 is a diagram illustrating an example of determination of one or more OLPC parameters at a UE

FIG. 7 is a diagram illustrating an example of signaling related to inference or prediction of OLPC parameters.

FIG. 8 is a diagram illustrating an example artificial intelligence (AI) architecture that may be used for AI-enhanced wireless communications.

FIG. 9 illustrates an example AI architecture of a first wireless device that is in communication with a second wireless device.

FIG. 10 is an illustrative block diagram of an example artificial neural network.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for user equipment open-loop power control parameter determination.

Open-loop power control (OLPC) is a technique used by a user equipment (UE) to control transmission power of the UE. In OLPC, the UE may perform power control without feedback from a base station. For example, the UE may receive a reference signal, estimate a signal strength of the reference signal, and adjust a transmit power of the UE based at least in part on the signal strength and a configuration of the UE. OLPC can be contrasted with closed-loop power control, in which the UE adjusts transmit power in accordance with a command received from a base station indicating to increase or decrease the transmit power.

Traditionally, OLPC has used certain parameters that are semi-statically configured, such as a target receiving power P₀ and a pathloss scaling factor α. These semi-statically configured OLPC parameters may provide limited flexibility due to their semi-static nature, which may be suitable for data communication on a longer timescale. However, as wireless communication technology advances, additional features (such as sensing) may be integrated with data communication, and performing OLPC in view of only data communication may lead to inefficient power allocation when these additional features are integrated. Furthermore, traffic characteristics of data communications are becoming more diverse, such as with more dynamic packet burst patterns and various quality of service (QoS) requirements (such as relating to multi-modal data), which may be inadequately served by semi-static OLPC parameters. Furthermore, as technology advances, UEs may collect more and more data, which increases the effectiveness of decision-making at the UE and enables a larger variety of data inputs to OLPC determination. Semi-statically configured OLPC parameters may not provide flexibility to take into account this larger variety of data inputs. Thus, in general, semi-statically configured OLPC parameters may create obstacles to effective management of transmit power in view of QoS requirements and/or available or desired energy, particularly for dynamic traffic or transmission profiles.

Aspects of the present disclosure relate generally to UE-side determination of OLPC parameters. Some aspects more specifically relate to transmission of a communication using one or more OLPC parameters that are based on a set of input parameters and an OLPC parameter determination at a UE. The one or more OLPC parameters may be associated with at least one of a QoS or an energy allocation. For example, the one or more OLPC parameters may provide a transmit power boost for a packet transmission associated with a relatively higher reliability requirement, a relatively lower latency requirement, a relatively higher priority, or a relatively higher energy budget or energy allocation. As another example, the one or more OLPC parameters may provide a transmit power reduction for a packet transmission associated with a relatively lower reliability requirement, a relatively more relaxed latency requirement, a relatively lower priority, or a relatively lower energy budget or energy allocation.

In some aspects, the one or more OLPC parameters may include a target receiving power parameter, a pathloss value, or a pathloss scaling factor. In some aspects, the set of input parameters may include an input parameter relating to a radio link status, a physical environment, a data traffic characteristic, UE information, or an AI/ML parameter. In some aspects, a network entity may provide a range or set of selectable values for the one or more OLPC parameters. The network entity may additionally provide an indication such as a reconfiguration of the range or set of selectable values, an activation or deactivation of the range or set of selectable values, or a fall back to a configured value for the one or more OLPC parameters.

Aspects of the present disclosure may be used to realize one or more of the following potential advantages. In some aspects, by determining the one or more OLPC parameters based on the set of input parameters, the UE improves flexibility of OLPC parameter determination and improves responsiveness of OLPC to conditions at the UE. Because the one or more OLPC parameters are associated with the QoS or the energy allocation, the one or more OLPC parameters may provide improved power control based on the QoS or the energy allocation. By determining the target receiving power, pathloss value, or pathloss scaling factor at the UE, latency associated with semi-statically configuring these values is reduced, and the determined values may be more appropriate in view of QoS or energy allocation than semi-statically determined values. By providing, reconfiguring, activating, or deactivating a range or set of selectable values, the network entity can guide the UE's determination of OLPC parameters such that preferences and requirements of the network entity are satisfied.

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

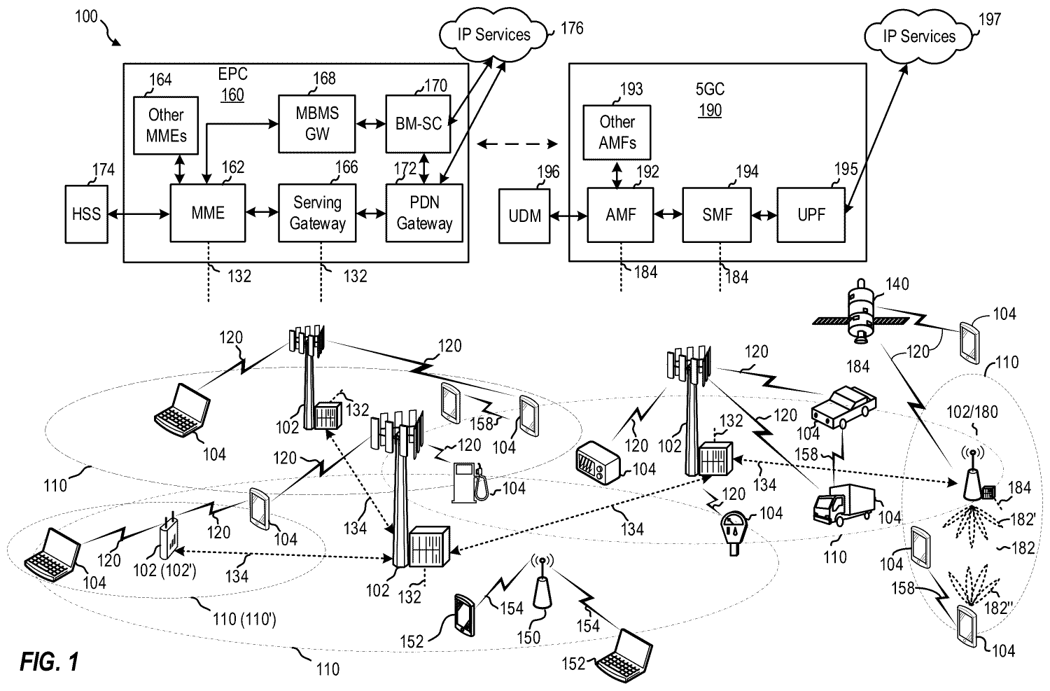

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

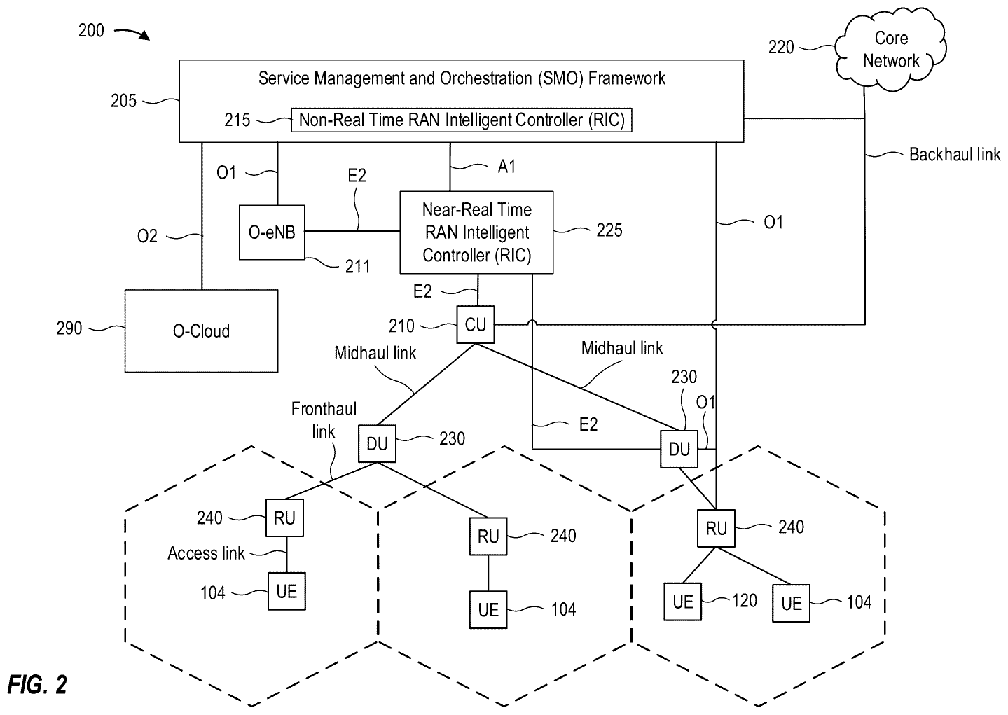

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-cNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

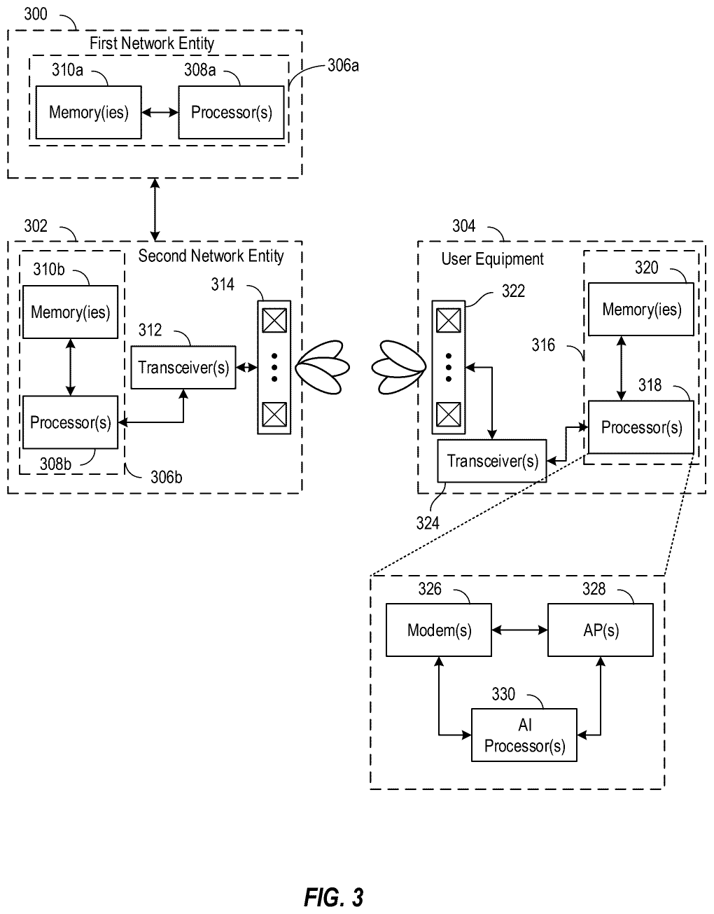

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

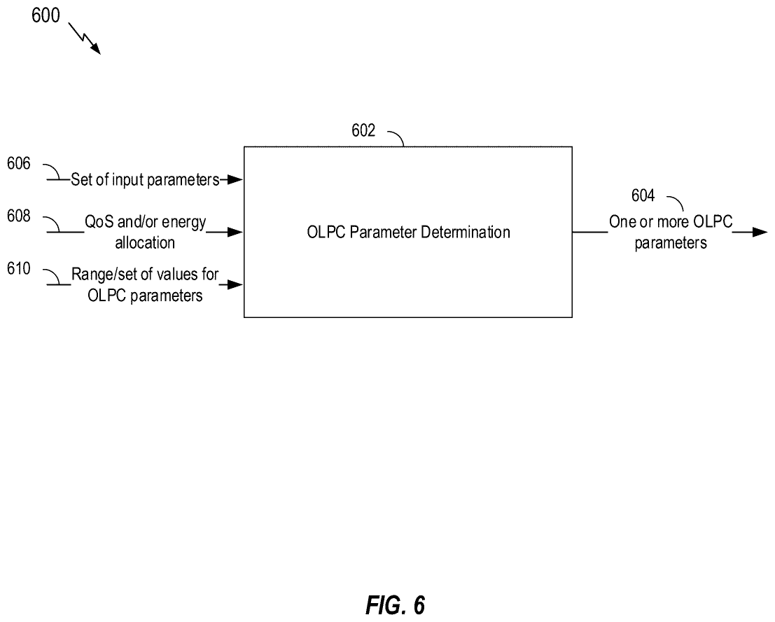

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc. In some aspects, the one or more AI processors may perform any one or more operations described with regard to FIGS. 6-10.

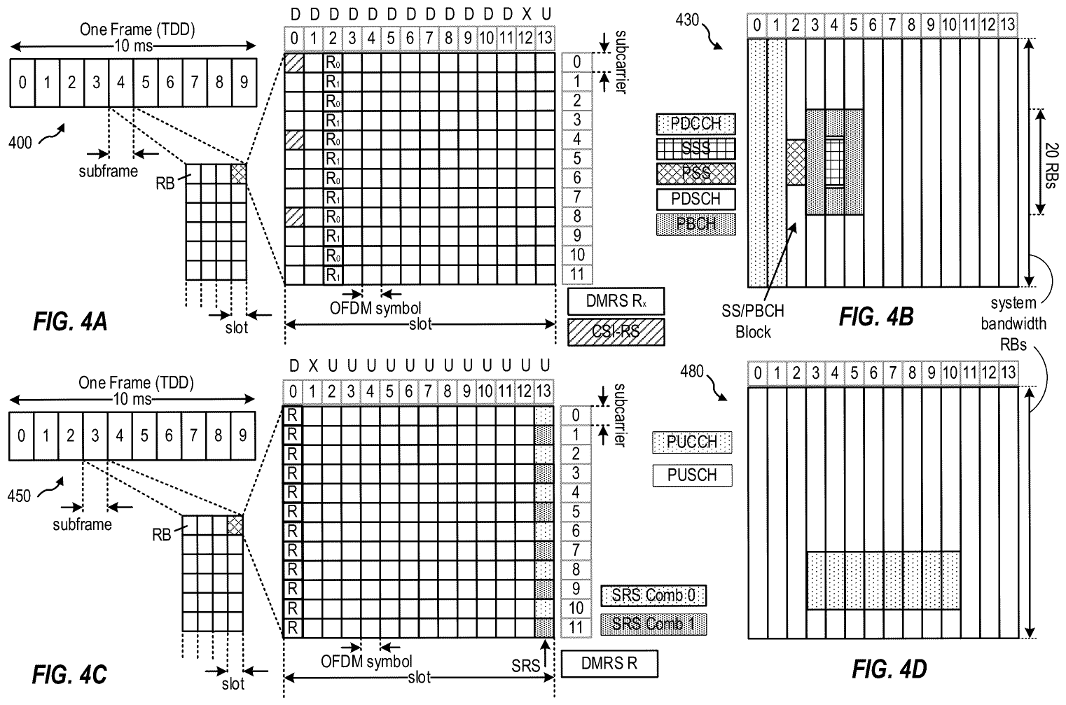

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 24× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

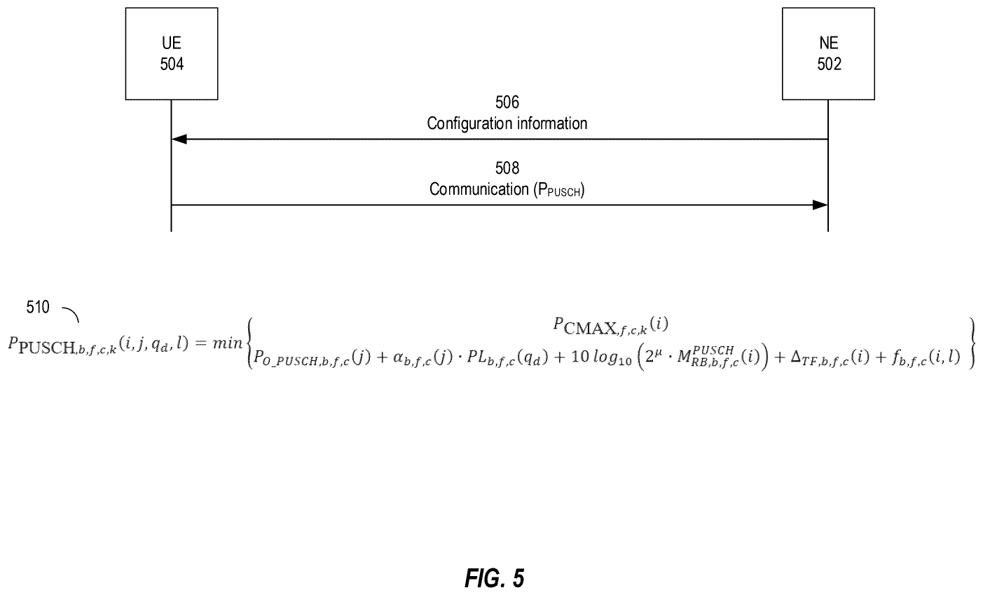

FIG. 5 is a diagram illustrating an example 500 of OLPC. Example 500 includes a network entity 502 and a UE 504. The network entity 502 may be an example of BS 102, network entity 300, or network entity 302. The UE 504 may be an example of UE 104 or UE 304.

As shown, the network entity 502 may transmit, and the UE 504 may receive, configuration information 506. For example, the configuration information 506 may include RRC signaling or another form of semi-static configuration. The configuration information 506 may include information that indicates an OLPC parameter or information used to determine an OLPC parameter. In example 500, one or more OLPC parameters used to transmit a communication 508 are derived from the configuration information 506 without using a set of input parameters described with respect to FIG. 6. Specific content of the configuration information 506 is described below in context with the OLPC parameters that this content is used to determine.

As shown, the UE 504 transmits a communication 508 using one or more OLPC parameters. In some aspects, the one or more OLPC parameters may include a scaling factor α_{b,f,c}(j) for a pathloss. In some aspects, the one or more OLPC parameters may include a target receiving power P_{0_PUSCH,b,f,c}(j) at the network entity 502.

The communication 508 may include a PUSCH communication. The UE 504 may transmit the PUSCH communication on an active uplink bandwidth part (denoted b) of a carrier (denoted f) of a serving cell (denoted c). The UE 504 may transmit the PUSCH communication on a PUSCH transmission occasion i using a parameter set configuration with index j and a PUSCH power control adjustment state with index l. In some aspects, the UE 504 is indicated a first TCI State (e.g., via a parameter TCI-State or TCI-UL-State) and a second TCI state (e.g., via a parameter TCI-State or TCI-UL-State), and is configured with multipanelScheme. The UE 504 determines to apply both the first TCI-State or TCI-UL-State and the second TCI-State or TCI-UL-State in PUSCH transmission occasion i. The UE may determine the PUSCH transmission power P_{PUSCH,b,f,c,k} (i, j, q_{d}, l) for the k-th indicated TCI-State or TCI-UL-State

Using this notation, the UE 504 may transmit the communication 508 for the kth indicated TCI-State or TCI-UL-State parameter at a transmit power P_{PUSCH,b,f,c,k}(i, j, q_{d}, l), which may be expressed in terms of decibel milliwatts (dBm) and determined according to Formula 1, illustrated in FIG. 5 by reference number 510. Below, certain parameters of Formula 1 are defined:
j=0 is used for MSG3 in random access, or PUSCH when P0-PUSCH-AlphaSet is not provided in the configuration information 506. j=1 is for configured grant and j≥2 is for dynamic grant.
P_{CMAX,f,c,k}(i) is the UE configured maximum output power for a transmission instance i, and may be provided in the configuration information 506.
P_{0_PUSCH,b,f,c} (j)=P_{O_NOMINAL,PUSCH,f,c}(j)+P_{O_UE_PUSCH,b,f,c} (j) is a target receiving power at the network entity 502 for a transmission configuration index j, when allocated a single resource block with 15 kHz subcarrier spacing and 0 dB pathloss.
α_{b,f,c}(j) is a scaling factor of pathloss for a transmission configuration index j, provided in the configuration information 506.
PL_{b,f,c}(q_{d}) is the pathloss measured with the RS (index q_{d}).

$${M}_{RB , b , f , c}^{PUSCH} ( i )$$

is the PUSCH resource assignment in number of resource blocks as indicated in downlink control information for a transmission instance i;

$${Δ}_{T F} ( i ) = 10 {log}_{10} ( ( {2}^{BPRE \cdot {K}_{s}} - 1 ) \cdot {β}_{offset}^{P U S C H} ) for {K}_{s} = 1.25 ,$$

$$and {Δ}_{T F , b , f , c} ( i ) = 0 for {K}_{s} = 0$$

(Kₛ is provided by deltaMCS, in the configuration information 506), for a transmission instance i.
f_{b,f,c}(i,l) is the closed-loop power control command indicated in DCI for transmission instance i and power control adjustment state l.

The pathloss, PL_{b,f,c}(q_{d}), may be determined by PL_{b,f,c}(q_{d})=referenceSignalPower (configured for an RS index q_{d} in the configuration information 506)—higher layer filtered reference signal received power (RSRP).

The scaling factor of pathloss, α_{b,f,c}(j), for a transmission configuration index j, may be determined by:
for random access (e.g., type 1) (j=0), α_{b,f,c} (0)=msg3-Alpha (from Alpha in PUSCH-PowerControl in the configuration information 506) or “1” (if not provided),
for configured grant (j=1), α_{b,f,c}(1)=alpha (from p0-PUSCH-Alpha in ConfiguredGrantConfig in the configuration information 506 via an index P0-PUSCH-AlphaSetId to a set of P0-PUSCH-AlphaSet in the configuration information 506), or
for dynamic grant (j≥2), α_{b,f,c}(j)=a set of alpha (in P0-PUSCH-AlphaSet indicated by a respective set of p0-PUSCH-AlphaSetId in the configuration information 506).

The target receiving power at the network entity 502, P_{0_PUSCH,b,f,c}(j), for a transmission configuration index j, may be determined as below:
for random access (e.g., type 1) (j=0), P_{0_PUSCH,b,f,c}(0)=P_{0_PRE} (by preambleReceivedTargetPower in RACH-ConfigGeneric in the configuration information 506)+Δ_{PREAMBLE_MSG3} (by msg3-DeltaPreamble in PUSCH-ConfigCommon in the configuration information 506) or “0” (if not provided), with P_{0_UE_PUSCH,b,f,c}(0)=0,
for configured grant (j=1), P_{0_PUSCH,b,f,c}(1)=p0-NominalWithoutGrant (from PUSCH-PowerControl in the configuration information 506) or P_{0_NOMIMAL_PUSCH,f,c} (0) (if not provided)+p0 (from p0-PUSCH-Alpha in ConfiguredGrantConfig via an index P0-PUSCH-AlphaSetId to a set of P0-PUSCH-AlphaSet in the configuration information 506), or
for dynamic grant (j≥2), P_{0_PUSCH,b,f,c}(j)=p0-NominalWithGrant (from PUSCH-ConfigCommon in the configuration information 506) or P_{0_NOMINAL_PUSCH,f,c} (0) (if not provided)+a set of p0 (in P0-PUSCH-AlphaSet indicated by a respective set of p0-PUSCH-AlphaSetId in the configuration information 506).

It can be seen that, in example 500, the OLPC parameters, including pathloss, the scaling factor for pathloss, and the target received power, are derived from parameters of the configuration information 506 and a measurement at the UE. Aspects described herein, such as with regard to FIGS. 6-10, provide determination of OLPC parameters based on a set of input parameters (e.g., input parameters 606) at the UE, such as using an artificial intelligence or machine learning model.

FIG. 6 is a diagram illustrating an example 600 of determination of one or more OLPC parameters at a UE. The operations of example 600 may be performed by a UE, such as UE 104 or UE 304.

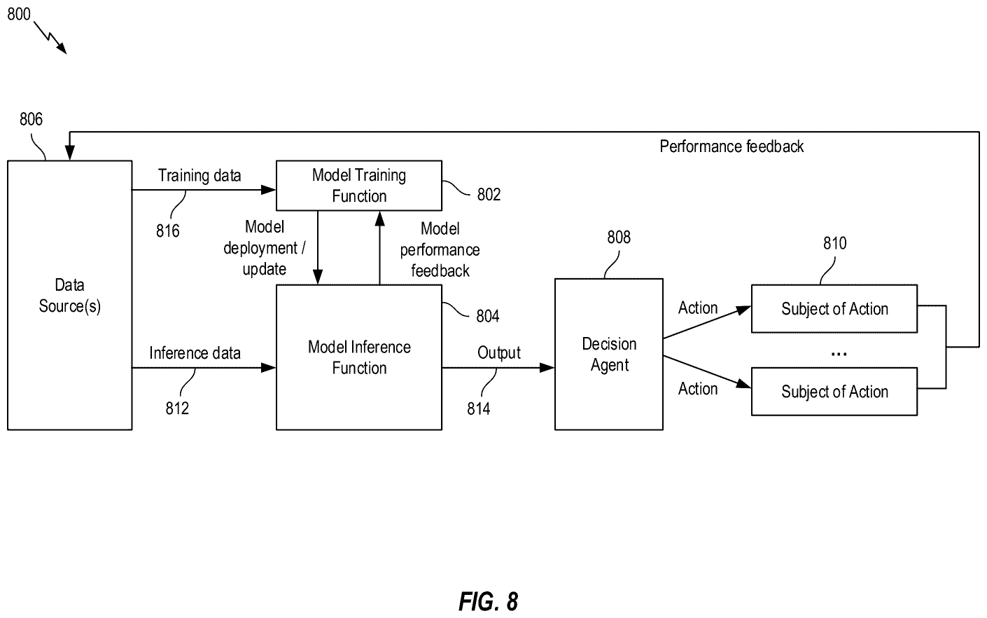

As shown, the UE is associated with an OLPC parameter determination component 602. The OLPC parameter determination component 602 may determine and/or predict one or more OLPC parameters 604. In some aspects, the one or more OLPC parameters 604 may include a pathloss (PL_{b,f,c}(q_{d})), such as a predicted pathloss. In some aspects, the one or more OLPC parameters may include a target receiving power (P_{0_PUSCH,b,f,c}(0) or P_{0_PUSCH,b,f,c}(1). In some aspects, the one or more OLPC parameters 604 may include a scaling factor (α_{b,f,c} (0) or α_{b,f,c} (1)) for a pathloss. In some aspects, the OLPC parameter determination component 602 may determine the one or more OLPC parameters 604 using an artificial intelligence or machine learning (AI/ML) functionality or model, as described with regard to FIGS. 8-10.

As shown, the OLPC parameter determination component 602 may receive, as input, a set of input parameters 606. For example, the UE may determine the set of input parameters 606. As another example, the UE may obtain information indicating the set of input parameters 606. As another example, the UE may predict an input parameter of the set of input parameters 606, such as using an AI/ML model. Examples of input parameters 606 are provided below. The AI/ML model is described in more detail in connection with FIGS. 8-10.

In some aspects, the set of input parameters 606 includes one or more input parameters associated with a radio link status. For example, the one or more input parameters may describe or be derived from the radio link status. For example, the one or more input parameters may include a radio link measurement or prediction (e.g., a measured or predicted Layer 1 beam-based measurement, a measured or predicted Layer 2 or Layer 3 filtered measurement). As another example, the one or more input parameters may include a measured or predicted channel propagation pattern (e.g., a line-of-sight (LOS) or non-LOS channel propagation pattern) or fading pattern. A channel propagation pattern may indicate a pattern of radio propagation of a channel (e.g., wireless environment) of the UE. A fading pattern may indicate a pattern of fading (e.g., signal attenuation) based on a location of the UE. As another example, the one or more input parameters may include a measured or predicted interference value (such as a cross-link interference value, an inter-symbol interference value, or the like). As another example, the one or more input parameters may include a radio map, which may indicate a distribution of signal strength across a geographic or spatial area.

In some aspects, the set of input parameters 606 includes one or more input parameters associated with a physical environment of the UE. For example, the one or more input parameters may describe or be derived from the physical environment of the UE. For example, the one or more input parameters may indicate a static blocking or reflecting object (e.g., a buildings, a structure, or a tree) and/or parameters describing the static blocking or reflecting object. As another example, the one or more input parameters may indicate a dynamic blocking or reflecting object (e.g., a moving vehicle), such as a detected dynamic blocking or reflecting object or a predicted dynamic blocking or reflecting object. As another example, the one or more input parameters may indicate a human body detection or prediction (e.g., associated with a maximum permissible exposure (MPE) regulation). As another example, the one or more input parameters may indicate one or more detected or predicted UEs (e.g., for determination or prediction of inter-UE interference).

In some aspects, the set of input parameters 606 includes one or more input parameters associated with a characteristic of data traffic. For example, the one or more input parameters may identify the characteristic of the data traffic. For example, the set of input parameters 606 may include a statistic or prediction of one or more data flow patterns associated with one or more QoS flows. For example, the one or more QoS flows may carry multi-modal data with different volume, latency, reliability, burst patterns, or arrival patterns. As another example, the set of input parameters 606 may include a statistic or prediction of one or more data flow patterns associated with one or more energy allocations (e.g., energy budgets). For example, such a data flow pattern may indicate a prediction or statistic regarding energy allocation (e.g., available energy for transmission, remaining energy budget) for a communication. In some aspects, the one or more input parameters may include a statistic or prediction regarding a buffer status report (BSR) (which indicates an amount of buffered traffic at the UE) or a delay status report (DSR) (which indicates an amount of delay for the buffered traffic at the UE). As another example, the one or more input parameters 606 may include a statistic or prediction of a number of retransmissions of a communication. As another example, the one or more input parameters 606 may include a statistic or prediction regarding a number of data drops of a communication (e.g., a number of times that data of a communication is dropped).

In some aspects, the set of input parameters 606 includes one or more input parameters associated with (e.g., identifying, indicating) UE information of the UE. For example, the UE information may include a UE location. As another example, the UE information may include a UE orientation (e.g., in X, Y, and/or Z axes). As another example, the UE information may include a UE velocity. As another example, the UE information may indicate a device temperature of the UE, which may assist with OLPC determination to avoid overheating of the UE. As another example, the UE information may indicate a battery level of the UE. As another example, the UE information may indicate a statistic or prediction regarding a transmit power of the UE. As another example, the UE information may indicate a transmit power map of the UE, which may indicate a distribution of transmit power across a geographic or spatial area.

In some aspects, the set of input parameters 606 includes one or more input parameters associated with an AI/ML model. For example, the one or more input parameters may include information related to operation or configuration of the AI/ML model. For example, the one or more input parameters may indicate a model architecture of the AI/ML model. As another example, the one or more input parameters may indicate a bit width of the AI/ML model. As another example, the one or more input parameters may indicate a lifetime span of the AI/ML model (e.g., an operational time span of the AI/ML model). As another example, the one or more input parameters may indicate a model update cycle (e.g., a timing of how or how often the AI/ML model is updated). As another example, the one or more input parameters may indicate an accuracy requirement (e.g., a threshold accuracy indicating whether the AI/ML model provides satisfactory performance). As another example, the one or more input parameters may indicate a misprediction or false alarm parameter (e.g., indicating whether the AI/ML model or another system should provide an indication or threshold level of misprediction or false alarm). In some aspects, the one or more input parameters associated with the AI/ML model may include one or more parameters for inference or prediction of (OLPC) parameters, such as one or more thresholds or event triggering conditions, one or more time-windows or timelines, one or more counters or timers, one or more rewards (e.g., power saving rewards, interference reduction rewards, scheduling rewords), or the like.

As shown, in some aspects, the OLPC parameter determination component 602 may receive information 608 regarding at least one of a QoS or an energy allocation. In some aspects, this information 608 may be included in the one or more input parameters 606. For example, information 608 regarding QoS may be received via one or more input parameters regarding a characteristic of data traffic to be communicated (e.g., relating to one or more QoS flows). As another example, information 608 regarding an energy allocation may be received via one or more input parameters regarding the characteristic of data traffic to be communicated (e.g., relating to an energy allocation which may include an energy budget).

Determination of the one or more OLPC parameters 604 may be associated with the QoS or the energy allocation. For example, in some aspects, the one or more OLPC parameters 604 may provide a power boost for a communication (e.g., a packet transmission) according to a QoS for the communication (such as a first threshold reliability that indicates a higher reliability for a reliability parameter, a first threshold latency that indicates a lower latency for a latency parameter, or a first threshold priority that indicates a higher priority for a priority parameter). In this example, the one or more OLPC parameters 604 may provide the power boost when the communication is configured or indicated with higher than or equal to the first threshold reliability (according to the reliability parameter), lower than or equal to the first threshold latency (according to the latency parameter), or higher than or equal to the first threshold priority (according to the priority parameter). The priority parameter, the reliability parameter, and/or the latency parameter may be included in the set of input parameters 606.

As another example, in some aspects, the one or more OLPC parameters 604 may provide a power reduction for a communication (e.g., a packet transmission) according to a QoS for the communication (such as a second threshold reliability that indicates a lower reliability for the reliability parameter, a second threshold latency that indicates a higher latency for the latency parameter, or a second threshold priority that indicates a lower priority for the priority parameter). In this example, the one or more OLPC parameters 604 may provide the power reduction when the communication is configured or indicated with lower than or equal to the second threshold reliability, higher than or equal to the second threshold latency, or lower than or equal to the second threshold priority.

As another example, in some aspects, the one or more OLPC parameters 604 may provide a power reduction for a communication (e.g., a packet transmission) according to an energy allocation (e.g., energy budget) for the communication. In this example, the one or more OLPC parameters 604 may provide the power boost when the energy allocation satisfies a condition (e.g., a sufficient amount of available energy or energy budget). As another example, in some aspects, the one or more OLPC parameters 604 may provide a power reduction for a communication (e.g., a packet transmission) according to an energy allocation (e.g., energy budget) for the communication. In this example, the one or more OLPC parameters 604 may provide the power reduction when the energy allocation fails to satisfy the condition (e.g., a sufficient amount of available energy or energy budget).

As shown by reference number 610, in some aspects, the OLPC parameter determination component 602 may use a range of selectable values (e.g., a range with a minimum value and maximum value (inclusive or not) or a set of selectable values (e.g., a_list or look up table with values) for the one or more OLPC parameters 604. For example, the OLPC parameter determination component 602 may select a value for the one or more OLPC parameters 604 from the range or set of selectable values. As another example, the range or set of selectable values may indicate selectable adjustments to an OLPC parameter 604, and the OLPC parameter determination component 602 may select an adjustment to the OLPC parameter 604 from the selectable adjustments.

Examples of ranges or sets of selectable values are described below. These examples are provided with regard to a scaling factor for a pathloss, but can also be applied for other types of OLPC parameters 604, such as a target receiving power or a pathloss.

In some aspects, a first table (Table 1) indicates an example set of selectable values for an adjusted pathloss scaling factor α′ based on power adjustments according to a factor Δα1 for power boost or a factor Δα2 for power reduction when an OLPC parameter 604 is to provide a power boost or power reduction for a communication:

TABLE 1

| Index | Adjusted pathloss scaling factor α′ set |
|---|---|
| 0 . . . 00 | Power boost level M: α + (M)* [symbol] α1 |
| 0 . . . 01 | Power boost level M-1: α + (M-1)* [symbol] α1 |
| 0 . . . 10 | . . . |
| . . . | Power boost level 1: α + (1)* [symbol] α1 |
| . . . | Nominal scaling factor: α |
| 1 . . . 00 | Power reduction level 1: α − (1)* [symbol] α2 |
| 1 . . . 01 | . . . |
| . . . | Power reduction level N-1: α − (N-1)* [symbol] α2 |
| | Power reduction level N: α − (N)* [symbol] α2 |

In Table 1, a first set of indexes are associated with power boost level values from 1 to M, and a second set of indexes are associated with power reduction level values from 1 to N. These power boost level values or power reduction level values may be applied in connection with a factor Δα1 for power boost or Δα2 for power reduction, where Δα1 and Δα2 may be different than one another or the same as one another. The power boost level values and the power reduction level values may be linearly distributed or non-linearly distributed. Thus, the OLPC parameter determination component 602 may select a power boost level or power reduction level, from the table, as a value of the adjusted pathloss scaling factor α′. In some aspects, a range of selectable values may indicate a maximum selectable value, a minimum selectable value, a step size of selectable values within the range, or a combination thereof.

In some aspects, the range or set of selectable values for an adjusted pathloss scaling factor α′ may directly indicate a pathloss scaling factor for power boost or pathloss scaling factor for power reduction. For example, a second table (Table 2) indicates an example set of selectable values when an OLPC parameter 604 is to provide a power boost or power reduction for a communication:

TABLE 2

| Index | Adjusted pathloss scaling factor α′ set |
|---|---|
| 0 ... 00 | $Power boost level M : {α}_{M}^{b}$ |
| 0 ... 01 | $Power boost level M - 1 : {α}_{M - 1}^{b}$ |
| 0 ... 10 | ... |
| ... | $Power boost level 1 : {α}_{1}^{b}$ |
| ... | Nominal scaling factor: α |
| 1 ... 00 | $Power reduction level 1 : {α}_{1}^{r}$ |
| 1 ... 01 | ... |
| ... | $Power reduction level N - 1 : {α}_{N - 1}^{r}$ |
| | $Power reduction level N : {α}_{N}^{r}$ |

In Table 2, a first set of indexes are associated with power boost level values from 1 to M, and a second set of indexes are associated with power reduction level values from 1 to N. The power boost level values and the power reduction level values may be linearly distributed or non-linearly distributed. Thus, the OLPC parameter determination component 602 may select a power boost level or power reduction level, from the table, as a value of the adjusted pathloss scaling factor α′. In some aspects, a range of selectable values may indicate a maximum selectable value, a minimum selectable value, a step size of selectable values within the range, or a combination thereof.

In some aspects, the range or set of selectable values may be based on a QoS. For example, a third table (Table 3) indicates an example set of selectable values for an OLPC parameter 604 and these selectable values are mapped to QoS flow identifiers:

TABLE 3

| QoS flow ID | Adjusted pathloss scaling factor α′ set |
|---|---|
| 0 ... 00 | $Power boost level M : α + ( M ) * Δ α1 or {α}_{M}^{b}$ |
| 0 ... 01 | $Power boost level M - 1 : α + ( M - 1 ) * Δ α1 or {α}_{M - 1}^{b}$ |
| 0 ... 10 | ... |
| ... | $Power boost level 1 : α + ( 1 ) * Δα1 or {α}_{1}^{b}$ |
| ... | Nominal scaling factor: α |
| 1 ... 00 | $Power reduction level 1 : α - ( 1 ) * Δα1 or {α}_{1}^{r}$ |
| 1 ... 01 | ... |
| ... | $Power reduction level N - 1 : α - ( N - 1 ) * Δα1 or {α}_{N - 1}^{r}$ |
| | $Power reduction level N : α - ( N ) * Δα1 or {α}_{N}^{r}$ |

In some aspects, the range or set of selectable values may be based on an energy allocation. For example, a fourth table (Table 4) indicates an example set of selectable values for an OLPC parameter 604 and these selectable values are mapped to indexes associated with respective energy allocations:

TABLE 4

| Energy | |
|---|---|
| allocation ID | Adjusted pathloss scaling factor α′ set |
| 0 ... 00 | $Power boost level M : α + ( M ) * Δ α1 or {α}_{M}^{b}$ |
| 0 ... 01 | $Power boost level M - 1 : α + ( M - 1 ) * Δ α1 or {α}_{M - 1}^{b}$ |
| 0 ... 10 | ... |
| ... | $Power boost level 1 : α + ( 1 ) * Δα1 or {α}_{1}^{b}$ |
| ... | Nominal scaling factor: α |
| 1 ... 00 | $Power reduction level 1 : α - ( 1 ) * Δα1 or {α}_{1}^{r}$ |
| 1 ... 01 | ... |
| ... | $Power reduction level N - 1 : α - ( N - 1 ) * Δα1 or {α}_{N - 1}^{r}$ |
| | $Power reduction level N : α - ( N ) * Δα1 or {α}_{N}^{r}$ |

In some aspects, a range of selectable values for adjusted pathloss scaling factor α′ may be denoted α_range. In some aspects, a set of selectable values for α′ may be denoted α_list. In some aspects, a range of selectable values for an adjusted target receiving power value

$${P}_{0}^{′}$$

may be denoted P_{0_range}. In some aspects, a set of selectable values for an adjusted target receiving power value

$${P}_{0}^{′}$$

may be denoted P_{0_list}.

As a first example, the UE may determine an OLPC parameter 604 comprising an adjusted target receiving power

$${P}_{0}^{′}$$

using the OLPC parameter determination component 602. A semi-static approach to specifying the target receiving power P₀ may impede flexibility for transmissions with different latency requirements (or other QoS requirements) or different energy allocations. For example, advancing wireless communication technologies may use beams that are narrower, which may provide more spatial isolation among UEs' uplink transmissions at the network entity's receiver. Therefore, the requirement of P₀ per cell may not be optimized for physical random access channel (PRACH) based uplink transmissions with different latency requirements (e.g., initial access, on-demand SIB1, beam failure recovery, etc.). Furthermore, a target receiving power (P₀) per UE for a configured grant may be limiting for uplink transmissions with different QoS requirements (e.g., latency or reliability) and/or different energy allocations. The UE may determine an adjusted target receiving power

$${P}_{0}^{′}$$

using OLPC parameter determination component 602 and using a set of input parameters 606. The set of input parameters 606 may include one or more parameters associated with a radio link status (e.g., a radio link measurement or prediction), a detected physical object, a QoS for data traffic, an energy allocation for data traffic, a UE location, UE mobility, or a combination thereof. These parameters are described in more detail above. The UE may identify an adjusted target receiving power,

$${P}_{0}^{′} ,$$

using the set of input parameters 606. For example, the UE may identify a higher adjusted target receiving power when an input parameter 606 indicates a stringent QoS requirement (e.g., latency or reliability). As another example, the UE may identify a lower adjusted target receiving power when an input parameter 606 indicates an energy allocation that is lower than a threshold. In some aspects, to identify an adjusted target receiving power

$${P}_{0}^{′} ,$$

the UE may infer or predict an adjusted target receiving power Value

$${P}_{0}^{\sim}$$

using the OLPC parameter determination component 602, and may select an adjusted target receiving power

$${P}_{0}^{′} ,$$

from a set or range of selectable values, according to the adjusted target receiving power value

$${P}_{0}^{\sim}$$

inferred or predicted. For example, the UE may select an adjustment that aligns a configured target receiving power value P₀, or may select a selectable value that matches the identified adjusted target receiving power value

$${P}_{0}^{′} .$$

As a second example, the UE may determine an OLPC parameter 604 comprising a pathloss PL using the OLPC parameter determination component 602. A semi-static approach to measuring or determining the pathloss may lead to an inaccurate pathloss determination (e.g., Layer 3 filtered measurement). For example, with low-latency bursty traffic, the UE may need transmit bursty data (e.g., an XR bursty transmission with configured grant) when out of a discontinuous reception (DRX) sleep mode, which may not provide enough time for determination of Layer 3 filtered RSRP of a reference signal that is quasi co-located with the transmit beam. As another example, with a beam failure request using PRACH, there may not be enough time to determine a Layer 3 filtered RSRP of the synchronization signal block (SSB) associated with the PRACH transmission. As another example, a semi-statically determined pathloss value may become inaccurate when the UE is moving away from (e.g., far field) or nearer to (e.g., near field) a network entity. Furthermore, pathloss values may vary on a short time scale in some situations. For example, in FR2, channel attenuation may vary dynamically, which may contribute to variance of pathloss. Furthermore, a UE with high mobility near a cell edge may experience much more variance of pathloss.

Continuing the second example, according to aspects described herein, the UE may determine a pathloss PL′ using OLPC parameter determination component 602 and using a set of input parameters 606. The set of input parameters 606 may include one or more parameters associated with a radio link status (e.g., a radio link measurement or prediction), a detected physical object, a UE location, UE mobility, or a combination thereof. These parameters are described in more detail above. The UE may identify the pathloss, PL′, using the set of input parameters 606. For example, the UE may identify a higher pathloss when an input parameter 606 indicates high mobility or low radio link quality or a physical obstruction or reflector. As another example, the UE may identify a lower pathloss when an input parameter 606 indicates that the UE is stationary, there is high link quality, or there is no physical obstruction or reflector. In some aspects, to identify the pathloss, the UE may infer or predict a pathloss value PL^{˜} using OLPC parameter determination component 602, and may select a pathloss PL′, from a set or range of selectable values, according to the pathloss value PL^{˜} inferred or predicted. For example, the UE may select an adjustment that aligns a configured or measured pathloss value PL, or may select a selectable value that matches the identified adjusted pathloss value PL′.

As a third example, the UE may determine an OLPC parameter 604 comprising a scaling factor α for a pathloss using the OLPC parameter determination component 602. A semi-static approach to specifying the scaling factor may impede flexibility for transmissions with different latency requirements (or other QoS requirements) or different energy allocations. For example, a fixed scaling factor α may not be suitable for physical random access channel (PRACH) based uplink transmissions with different latency requirements (e.g., initial access, on-demand SIB1, beam failure recovery, etc.). Furthermore, a fixed scaling factor α per UE for a configured grant may be limiting for uplink transmissions with different QoS requirements (e.g., latency or reliability) and/or different energy allocations

Continuing the third example, according to aspects described herein, the UE may determine an adjusted pathloss scaling factor α′ using OLPC parameter determination component 602 and using a set of input parameters 606. The set of input parameters 606 may include one or more parameters associated with a radio link status (e.g., a radio link measurement or prediction), a detected physical object, a UE location, UE mobility, or a combination thereof. These parameters are described in more detail above. The UE may identify an adjusted pathloss scaling factor α′ using the set of input parameters 606. For example, the UE may identify a higher scaling factor (to implement a power boost) when an input parameter 606 indicates high mobility or low radio link quality or a physical obstruction or reflector. As another example, the UE may identify a lower scaling factor (to implement a power reduction) when an input parameter 606 indicates that the UE is stationary, there is high link quality, or there is no physical obstruction or reflector. In some aspects, to identify the scaling factor, the UE may infer or predict an adjusted pathloss scaling factor value α^{˜} using OLPC parameter determination component 602, and may select an adjusted pathloss scaling factor α′, from a set or range of selectable values, according to the scaling factor value α^{˜}inferred or predicted. For example, the UE may select an adjustment that aligns a configured pathloss scaling factor with the identified scaling factor value α, or may select a selectable value that matches the identified scaling factor value α′.

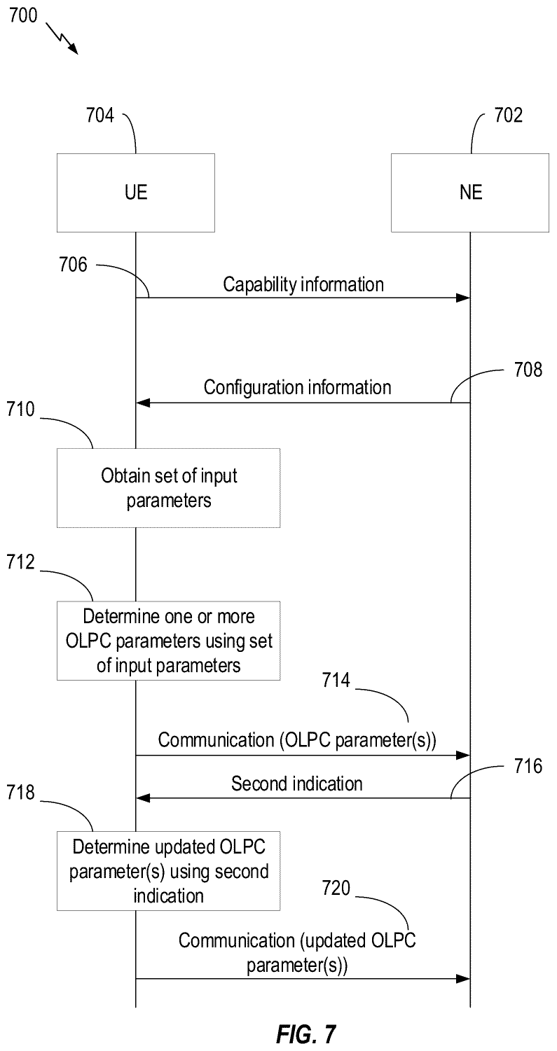

Signaling related to prediction of OLPC parameters 604 is described in connection with FIG. 7.

FIG. 7 is a diagram illustrating an example 700 of signaling related to inference or prediction of OLPC parameters. Example 700 includes a UE 704 (e.g., UE 104, UE 304) and a network entity 702 (e.g., BS 102, network entity 300, or network entity 302).

As shown, in some aspects, the UE 704 may send, and the network entity 702 may receive, capability information 706. The capability information 706 may indicate one or more capabilities regarding determination of OLPC parameters (e.g., OLPC parameters 604) at the UE 704. For example, the capability information 706 may indicate that the UE supports determination of OLPC parameters at the UE 704 (e.g., using OLPC parameter determination component 602). As another example, the capability information 706 may indicate one or more types of OLPC parameters the UE 704 can determine. As another example, the capability information 706 may indicate supported values for the OLPC parameters, such as a supported range of selectable values, a supported set of selectable values, or the like. As another example, the capability information 706 may indicate one or more AI/ML models or functionalities supported by the UE 704 for determination of OLPC parameters.

As shown, in some aspects, the network entity 702 may send, and the UE 704 may receive, configuration information 708. The configuration information 708 may include a configuration related to UE-side determination of OLPC parameters. In some aspects, the configuration information 708 may configure one or more ranges of selectable values, as described in connection with FIG. 6. Additionally, or alternatively, the configuration information 708 may configure one or more sets of selectable values, as described in connection with FIG. 6. For example, the configuration information 708 may indicate a respective range of selectable values and/or a respective set of selectable values for each OLPC parameter determinable by the UE 704.

In some aspects, the configuration information 708 may indicate a range of selectable values or a set of selectable values. For example, the configuration information 708 may indicate, for determination of a given OLPC parameter, at least one of a plurality of configured ranges of selectable values. As another example, the configuration information 708 may indicate, for determination of a given OLPC parameter, at least one of a plurality of configured sets of selectable values.

As shown, at 710, the UE 704 may obtain a set of input parameters (e.g., a set of input parameters 606). For example, the UE 704 may measure, predict, or infer the set of input parameters. Additionally, the UE 704 may receive information from upper layer such as service layer or application layer or operation system (e.g., the QoS flows and data traffic pattens of a service or application packet transmissions, power allocation or power level, device temperature, UE location or velocity, or the like). The set of input parameters are described in more detail in connection with FIG. 6.

As shown, at 712, the UE 704 may determine one or more OLPC parameters (e.g., OLPC parameters 604) using the set of input parameters. For example, an OLPC parameter determination component 602 of the UE 704 may infer or predict the one or more OLPC parameters or determine (based on the inference or prediction) the one or more OLPC parameters (e.g., using a set of selectable values or range of selectable values described with regard to FIG. 6). The determination of the one or more OLPC parameters is described in more detail in connection with FIG. 6.

The determination of the one or more OLPC parameters may be associated with at least one of a QoS or an energy allocation. For example, the determination of the one or more OLPC parameters may be associated with the QoS in that an input parameter used to determine the one or more OLPC parameters may relate to a QoS. As another example, the determination of the one or more OLPC parameters may be associated with the QoS in that the UE may determine a transmit power boost (via the one or more OLPC parameters) for a communication 714 associated with a more stringent QoS, or a transmit power reduction for a communication 714 associated with a less stringent QoS. For example, the determination of the one or more OLPC parameters may be associated with the energy allocation in that an input parameter used to determine the one or more OLPC parameters may relate to an energy allocation (e.g., energy budget). As another example, the determination of the one or more OLPC parameters may be associated with the energy allocation in that the UE may determine a transmit power boost (via the one or more OLPC parameters) for a communication 714 associated with a larger energy allocation, or a transmit power reduction for a communication 714 associated with a smaller energy allocation.

As shown, the UE 704 may transmit a communication 714 using the one or more OLPC parameters. For example, the UE 704 may determine a transmit power (P_{PUSCH}) for the communication 714 using the one or more OLPC parameters (e.g., the pathloss, the scaling factor for the pathloss, or the target receiving power), and may transmit the communication 714 using the transmit power.

At 716, the network entity 702 may send, and the UE 704 may receive, a second indication. In some aspects, the second indication may include a modification to determination of an OLPC parameter at the UE 704. The second indication may be sent via any suitable form of signaling, such as RRC message, MAC CE, or DCI signaling, or the like.

In some aspects, the second indication may include a reconfiguration of the range of selectable values or the set of selectable values. For example, the second indication may change one or more values of a range of selectable values. As another example, the second indication may change one or more values of a set of selectable values. In such examples, the UE 704, when determining an updated OLPC parameter at 718, may determine the updated OLPC parameter using the changed range or set of selectable values.

As another example, the second indication may include an activation of the range of selectable values or the set of selectable values. For example, the second indication may indicate a range of selectable values, from multiple configured ranges of selected values. As another example, the second indication may indicate a set of selectable values, from multiple configured sets of selectable values. In such examples, the UE 704, when determining an updated OLPC parameter at 718, may determine the updated OLPC parameter using the activated range or set of selectable values.

As another example, the second indication may include a deactivation of the range of selectable values or the set of selectable values. For example, the second indication may indicate a range of selectable values, from multiple configured ranges of selected values, to be deactivated for OLPC parameter determination. As another example, the second indication may indicate a set of selectable values, from multiple configured sets of selectable values, to be deactivated for OLPC parameter determination. In such examples, the UE 704, when determining an updated OLPC parameter at 718, may determine the updated OLPC parameter using a range or set of selectable values other than the deactivated range or set of selectable values.

As another example, the second indication may include a fall back to a configured value for the one or more OLPC parameters. For example, the second indication may indicate for the UE 704 to determine the updated OLPC parameter at 718 using a configured value (as described with respect to FIG. 5) rather than an OLPC parameter determined by the OLPC parameter determination component 602.

In some aspects, the network entity 702 may send the second indication based on a system interference level. For example, when system interference (e.g., interference measured at the network entity 702 and/or a UE 704, and representing a total level of interference in the system) satisfies a threshold, the network entity 702 may adjust the range(s) or set(s) of selectable values for OLPC parameter determination such that transmit power of UEs is reduced, thereby mitigating the system interference.

In some aspects, the network entity 702 may send the second indication based on a system throughput. For example, when system throughput (e.g., a total level of throughput between the network entity 702 and a set of UE 704 served by the network entity 702) is lower than a threshold, the network entity 702 may adjust the range(s) or set(s) of selectable values for OLPC parameter determination such that transmit power of UEs is increased, thereby increasing the system throughput. When system throughput is higher than the threshold, the network entity 702 may adjust OLPC parameter determination such that transmit power of UEs is decreased, thereby conserving power.

In some aspects, the network entity 702 may send the second indication based on a number of UEs transmitting to the network entity 702. For example, when the number of UEs is greater than a threshold, the network entity 702 may adjust the range(s) or set(s) of selectable values for OLPC parameter determination such that transmit power of the UEs is decreased, thereby decreasing interference between the UEs.

In some aspects, the network entity 702 may send the second indication based on a received power of one or more transmissions using the OLPC parameter determined by the UE 704 and/or decoding performance of one or more transmissions using the OLPC parameter determined by the UE 704. For example, when the received power is lower than a threshold (e.g., lower than a target receiving power), the network entity 702 may adjust the range(s) or set(s) of selectable values for OLPC parameter determination such that the received power is increased to satisfy the threshold.

Additionally, or alternatively, the network entity 702 may send the second indication to reconfigure, activate, deactivate the other parameters as described in the connection with the reference number 606 in FIG. 6. For example, the AI/ML model may be updated, activated or deactivated based on the monitoring of the performance such as accuracy, misprediction or false alarm. For example, the parameters (e.g., threshold or triggering condition, time windows or timelines, counters or timers, policy or rewards, mapping to vector space, or the like) for inference or prediction of OLPC parameters may be reconfigured, activated or deactivated based on the monitoring of the AI/ML performance.

At 718, the UE 704 may determine an updated OLPC parameter. For example, the UE 704 may determine the updated OLPC parameter according to the second indication described with respect to 716. In some aspects, the UE 704 may determine the updated OLPC parameter using the OLPC parameter determination component 602. In some other aspects (e.g., where the second indication indicates to fall back to the configured value), the UE 704 may determine the updated OLPC parameter as described with respect to FIG. 5. At 720, the UE 704 may send, and the network entity 702 may receive, a second communication using the updated OLPC parameter.

FIG. 8 is a diagram illustrating an example AI architecture 800 that may be used for AI-enhanced wireless communications. As illustrated, the architecture 800 includes multiple logical function entities, such as a model training function 802, a model inference function 804, data source(s) 806, and a decision agent 808, which may be an element or an entity of a wireless communications network (e.g., a UE 104 or 304, a network entity 300 or 302, a disaggregated network entity including a CU, a DU, and/or an RU, or a RIC in a cloud-based RAN, among some examples). The AI architecture may be used in any of various use cases for wireless communications, such as those described above with regard to FIGS. 5-7.

The model inference function 804, in the architecture 800, is configured to run an ML model (e.g., in connection with OLPC parameter determination component 602) based on inference data 812 provided by data source(s) 806 (e.g., at an edge or cloud server or at a UE). The model inference function 804 (e.g., at an edge or cloud server or at a UE) may produce an output 814 (e.g., a predicted value, such as one or more discrete values or a continuous value range or one or more hard (deterministic) or soft (suggested or each associated with a probability or weight) values for P₀, α^{˜} or PL^{˜} as described in the connection with the reference number 604 in FIG. 6) based on the inference data 812 (e.g., the input parameters as described in the connection with the reference numbers 606 and 608 in FIG. 6), that is then provided as input to the decision agent 808. In some aspects, the output 814 may relate to an OLPC parameter, as described elsewhere herein.

The decision agent 808 may be an element or an entity of a wireless communications network (such as wireless communications network 100). For example, the decision agent 808 may be a UE 104 or 304, a network entity 300 or 302, a disaggregated network entity including a CU, a DU, and/or an RU, or a RIC in a cloud-based RAN, among some examples. Additionally, a type of decision agent 808 may depend on the type of tasks performed by the model inference function 804, the type of inference data 812 provided to model inference function 804, and/or the type of output 814 produced by model inference function 804. For example, if output 814 from the model inference function 804 (e.g., at an edge or cloud server or at a UE) is associated with OLPC parameter determination/inference/prediction, the decision agent 808 may be or include a UE.

After the decision agent 808 receives output 814 from the model inference function 804, decision agent 808 may determine whether to act based on the output. For example, the decision agent 808 may be a UE, and the output 814 from model inference function 804 may be an OLPC parameter inferred or predicted (e.g., OLPC parameter

$${P}_{0}^{∼} , {α}^{∼} or {PL}^{∼} ) .$$

For example, the model inference function 804 may predict or infer OLPC parameters

$$( {P}_{0}^{∼} , {α}^{∼} or {PL}^{∼} )$$

for a UE based on inference data input (e.g., the input parameters as described in the connection with the reference numbers 606 and 608 in FIG. 6). Based on the predicted or inferred OLPC parameters

$$( {P}_{0}^{∼} , {α}^{∼} or {PL}^{∼} ) ,$$

the decision agent 808, such as the UE, may send, to the subject of action 810, such as a transceiver of the UE, an OLPC parameter for a transmission by the UE. In some cases, the decision agent 808 and the subject of action 810 are the same entity (e.g., a decision or action associated with one or more OLPC parameters with a power boost or a power reduction).

The data sources 806 may be configured for collecting data that is used as training data 816 for training an ML model (e.g., by Model Training Function 802), or as inference data 812 for feeding an ML model inference operation (e.g., Model Inference Function 804). In particular, the data sources 806 may collect data from any of various entities (e.g., the UE and/or the BS), which may include the subject of action 810, and provide the collected data to a model training function 802 for ML model training. For example, after a subject of action 810 (e.g., a UE) receives an OLPC parameter from decision agent 808, the subject of action 810 may provide performance feedback associated with the OLPC parameters to the data sources 806, where the performance feedback may be used by the model training function 802 for monitoring and/or evaluating the ML model performance, such as whether the output 814, provided to decision agent 808, is accurate. In some examples, if the output 814 provided to decision agent 808 is inaccurate (or the accuracy is below an accuracy threshold), the model training function 802 may determine to modify or retrain the ML model used by model inference function 804, such as via an ML model deployment/update or activation/deactivation (e.g., by the UE or BS).

In certain aspects, the model training function 802 may be deployed at or with the same or a different entity than that in which the model inference function 804 is deployed. For example, in order to offload model training processing, which can impact the performance of the model inference function 804, the model training function 802 may be deployed at a model server as further described herein. Further, in some cases, training and/or inference may be deployed at edge or cloud server; in some other cases, training and/or inference may be distributed amongst devices (UEs) in a decentralized or federated fashion.

In some other aspects, an ML model is deployed at an edge or cloud server or on a UE (e.g., at OLPC parameter determination component 602) for OLPC parameter determination. More specifically, a model inference function, such as model inference host function in FIG. 8, may be deployed at an edge or cloud server or on the UE for OLPC parameter determination.

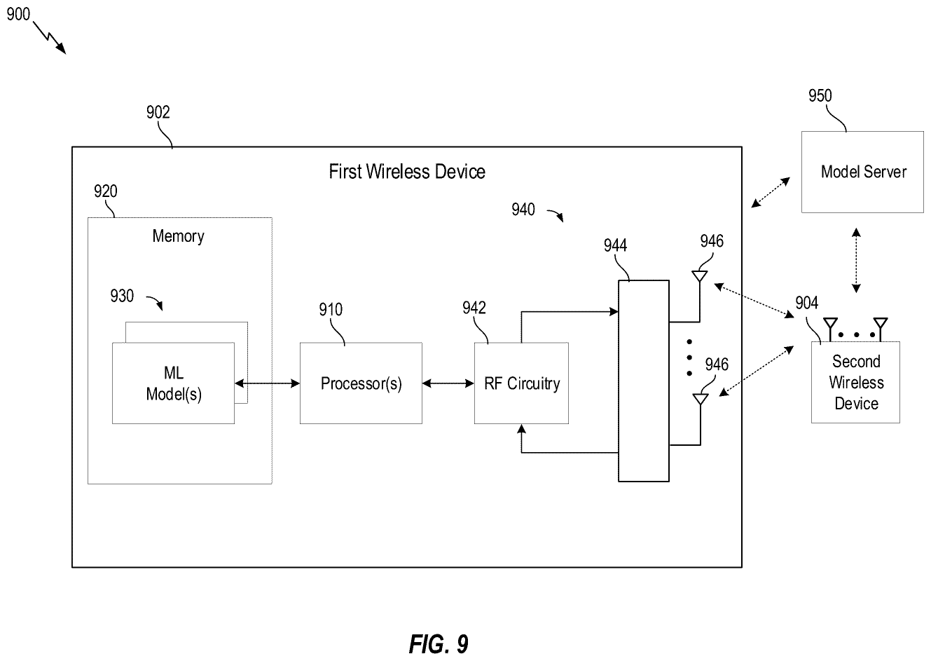

FIG. 9 illustrates an example AI architecture 900 of a first wireless device 902 that is in communication with a second wireless device 904. The first wireless device 902 may be a UE described herein, such as UE 104 or 304 as described herein with respect to FIGS. 1 and 3. Similarly, the second wireless device 904 may be an NE described herein, such as BS 102 or NE 300/302 as described herein with respect to FIGS. 1 and 3. Note that the AI architecture of the first wireless device 902 may be applied to the second wireless device 904.

The first wireless device 902 may be, or may include, a chip, SoC, a SiP, chipset, package or device that includes one or more processors, processing blocks or processing elements (collectively “the processor 910”) and one or more memory blocks or elements (collectively “the memory 920”).

As an example, in a transmit mode, the processor 910 may transform information (e.g., packets or data blocks) into modulated symbols. As digital baseband signals (e.g., digital in-phase (I) and/or quadrature (Q) baseband signals representative of the respective symbols), the processor 910 may output the modulated symbols to a transceiver 940. The processor 910 may be coupled to the transceiver 940 for transmitting and/or receiving signals via one or more antennas 946. In this example, the transceiver 940 includes RF circuitry 942, which may be coupled to the antennas 946 via an interface 944. As an example, the interface 944 may include a switch, a duplexer, a diplexer, a multiplexer, and/or the like. The RF circuitry 942 may convert the digital signals to analog baseband signals, for example, using a digital-to-analog converter. The RF circuitry 942 may include any of various circuitry, including, for example, baseband filter(s), mixer(s), frequency synthesizer(s), power amplifier(s), and/or low noise amplifier(s). In some cases, the RF circuitry 942 may upconvert the baseband signals to one or more carrier frequencies for transmission. The antennas 946 may emit RF signals, which may be received at the second wireless device 904.

In receive mode, RF signals received via the antenna 946 (e.g., from the second wireless device 904) may be amplified and converted to a baseband frequency (e.g., downconverted). The received baseband signals may be filtered and converted to digital I or Q signals for digital signal processing. The processor 910 may receive the digital I or Q signals and further process the digital signals, for example, demodulating the digital signals.

One or more ML models 930 may be stored in the memory 920 and accessible to the processor(s) 910. In certain cases, different ML models 930 with different characteristics may be stored in the memory 920, and a particular ML model 930 may be selected based on its characteristics and/or application as well as characteristics and/or conditions of first wireless device 902 (e.g., a power state, a mobility state, a battery reserve, a temperature, etc.). For example, the ML models 930 may have different inference data and output pairings (e.g., different types of inference data produce different types of output), different levels of accuracies (e.g., 80%, 90%, or 95% accurate) associated with the predictions, different latencies (e.g., processing times of less than 10 ms, 100 ms, or 1 second) associated with producing the predictions, different ML model sizes (e.g., file sizes), different coefficients or weights, etc. In some aspects, an ML model selection or deployment for OLPC parameters may be based on the AI/ML model parameters configured or activated by the network for managing the performance of the AI/ML model inference (e.g., described in details in the connection with the reference number 606 in FIG. 6).

The processor 910 may use the ML model 930 to produce output data (e.g., the OLPC parameters 604) based on input data (e.g., the set of input parameters 606), for example, as described herein with respect to the inference function 804 of FIG. 8. The ML model 930 may be used to perform any of various AI-enhanced tasks, such as those listed above.

In certain aspects, a model server 950 may perform any of various ML model lifecycle management (LCM) tasks for the first wireless device 902 and/or the second wireless device 904. The model server 950 may operate as the model training function 802 and update the ML model 930 using training data. In some cases, the model server 950 may operate as the data source 806 to collect and host training data, inference data, and/or performance feedback associated with an ML model 930. In certain aspects, the model server 950 may host various types and/or versions of the ML models 930 for the first wireless device 902 and/or the second wireless device 904 to download.

In some cases, the model server 950 may monitor and evaluate the performance of the ML model 930 to trigger one or more LCM tasks. For example, the model server 950 may determine whether to activate or deactivate the use of a particular ML model at the first wireless device 902 and/or the second wireless device 904, and the model server 950 may provide such an instruction to the respective first wireless device 902 and/or the second wireless device 904 (e.g., an indication from the network as described in the connection with the reference numbers 708 and 716 in FIG. 7). In some cases, the model server 950 may determine whether to switch to a different ML model 930 being used at the first wireless device 902 and/or the second wireless device 904, and the model server 950 may provide such an instruction to the respective first wireless device 902 and/or the second wireless device 904 (e.g., an indication from the network as described in the connection with the reference numbers 708 and 716 in FIG. 7). In yet further examples, the model server 950 may also act as a central server for decentralized machine learning tasks, such as federated learning.

### Example Artificial Intelligence Model

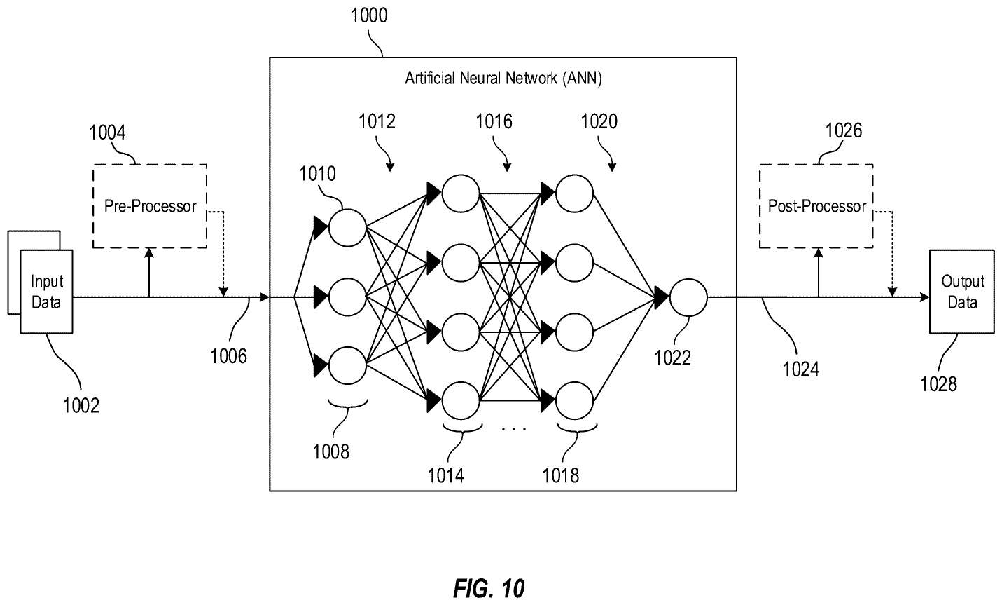

FIG. 10 is an illustrative block diagram of an example artificial neural network (ANN) 1000. ANN 1000 may be an example of ML model 930, and may be implemented at OLPC parameter determination component 602.

ANN 1000 may receive input data 1006 which may include one or more bits of data 1002, pre-processed data output from pre-processor 1004 (optional), or some combination thereof. Here, data 1002 (e.g., as described in the connection with the reference numbers 606 and 608 in FIG. 6) may include training data, verification data, application-related data, or the like, e.g., depending on the stage of development and/or deployment of ANN 1000. Pre-processor 1004 may be included within ANN 1000 in some other implementations. Pre-processor 1004 may, for example, process all or a portion of data 1002 which may result in some of data 1002 being changed, replaced, deleted, etc. In some implementations, pre-processor 1004 may add additional data to data 1002.

ANN 1000 includes at least one first layer 1008 of artificial neurons 1010 (e.g., perceptrons) to process input data 1006 and provide resulting first layer output data via edges 1012 to at least a portion of at least one second layer 1014. Second layer 1014 processes data received via edges 1012 and provides second layer output data via edges 1016 to at least a portion of at least one third layer 1018. Third layer 1018 processes data received via edges 1016 and provides third layer output data via edges 1020 to at least a portion of a final layer 1022 including one or more neurons to provide output data 1024. All or part of output data 1024 may be further processed in some manner by (optional) post-processor 1026. Thus, in certain examples, ANN 1000 may provide output data 1028 (e.g., the predicted or inferred OLPC parameter such as

$${P}_{0}^{∼} , {α}^{∼} or {PL}^{∼}$$

as described in FIGS. 6-9) that is based on output data 1024, post-processed data output from post-processor 1026, or some combination thereof. Post-processor 1026 may be included within ANN 1000 in some other implementations. Post-processor 1026 may, for example, process all or a portion of output data 1024 which may result in output data 1028 being different, at least in part, to output data 1024, e.g., as result of data being changed, replaced, deleted, etc. In some implementations, post-processor 1026 may be configured to add additional data to output data 1024. In this example, second layer 1014 and third layer 1018 represent intermediate or hidden layers that may be arranged in a hierarchical or other like structure. Although not explicitly shown, there may be one or more further intermediate layers between the second layer 1014 and the third layer 1018.

The structure and training of artificial neurons 1010 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data. Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 1000 and a number of layers and a number of artificial neurons in each layer, as well as selecting activation functions, a loss function, training processes, etc. Once an initial model has been designed, training of the model may be conducted using training data. Training data may include one or more datasets within which ANN 1000 may detect, determine, identify or ascertain patterns. Training data may represent various types of information, including written, visual, audio, environmental context, operational properties, etc. During training, parameters of artificial neurons 1010 may be changed, such as to minimize or otherwise reduce a loss function or a cost function. A training process may be repeated multiple times to fine-tune ANN 1000 with each iteration.

For example, ANN 1000 or another AI/ML model or functionality may be trained to perform OLPC parameter determination (such as at a model training host 802). For example, a training dataset may include input information (such as a set of input parameters 606) together with corresponding OLPC parameters (such as one or more OLPC parameters 604). An input of the ANN 1000 may include the set of input parameters 606. An output of the ANN 1000 may include the one or more OLPC parameters 604.

ANN 1000 or other ML models may be implemented in various types of processing circuits along with memory and applicable instructions therein, for example, as described herein with respect to FIGS. 8 and 9. For example, general-purpose hardware circuits, such as, such as one or more CPUs and one or more graphics processing units (GPUs) may be employed to implement a model. One or more ML accelerators, such as tensor processing units (TPUs), embedded neural processing units (cNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more UEs, one or more network entities, or one or more other devices in a wireless communication system. In some cases, all or part of the training data may be aggregated from multiple sources (e.g., one or more UEs, one or more network entities, the Internet, etc.). For example, wireless network architectures, such as SONs or minimization of drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, the ML model's performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 1000 of FIG. 10, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model. Pruning techniques may be particularly useful in the context of wireless communication, where the available resources (such as power and bandwidth) may be limited.

One or more of the example training techniques presented above may be employed as part of a training process. As above, some example training processes that may be used to train an ML model include supervised learning, unsupervised learning, semi-supervised learning, and reinforcement learning technique.

### Example Operations of a User Equipment

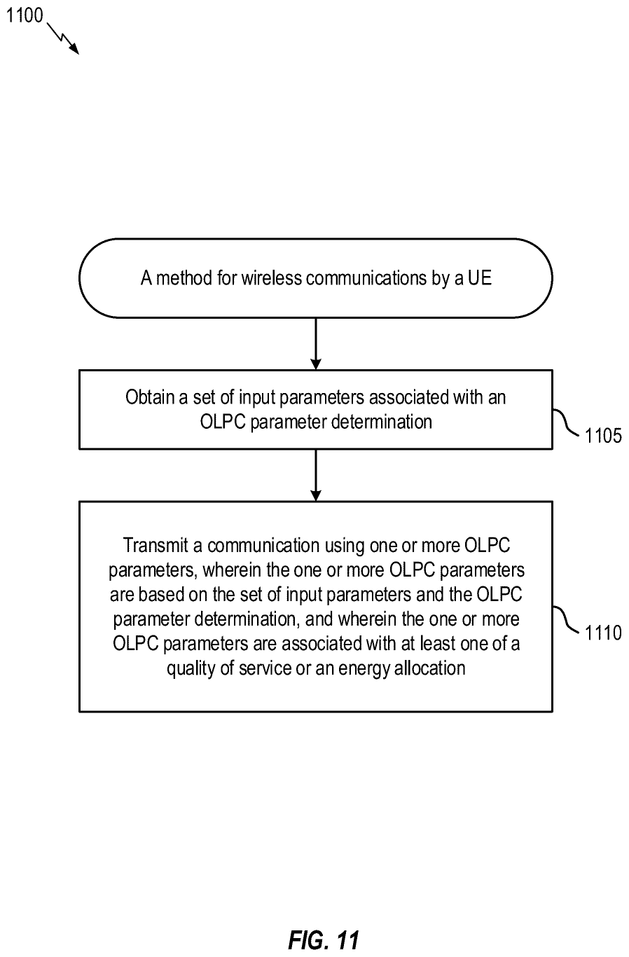

FIG. 11 shows a method 1100 for wireless communications by an apparatus, such as UE 104 of FIG. 1 or UE 304 of FIG. 3.

Method 1100 begins at block 1105 with obtaining a set of input parameters associated with an OLPC parameter determination.

Method 1100 then proceeds to block 1110 with transmitting a communication using one or more OLPC parameters, wherein the one or more OLPC parameters are based on the set of input parameters and the OLPC parameter determination, and wherein the one or more OLPC parameters are associated with at least one of a quality of service or an energy allocation.

In some aspects, the one or more OLPC parameters are associated with the quality of service based on at least one of: a reliability parameter associated with the communication, a latency parameter associated with the communication, or a priority parameter associated with the communication.

In some aspects, the one or more OLPC parameters are associated with the energy allocation based on at least one of: an energy budget associated with the communication, or an energy allocation associated with the communication.

In some aspects, the set of input parameters includes one or more input parameters associated with a radio link status.

In some aspects, the set of input parameters includes one or more input parameters associated with a physical environment of the UE.

In some aspects, the set of input parameters includes one or more input parameters associated with a characteristic of data traffic.

In some aspects, the set of input parameters includes one or more input parameters associated with UE information of the UE.

In some aspects, the set of input parameters includes one or more input parameters associated with an artificial intelligence or machine learning model.

In some aspects, the one or more OLPC parameters include a target receiving power parameter.

In some aspects, the one or more OLPC parameters include a pathloss parameter.

In some aspects, the one or more OLPC parameters include a scaling factor for a pathloss parameter.

In some aspects, method 1100 further includes performing the OLPC parameter determination to determine the one or more OLPC parameters based on the set of input parameters.

In some aspects, performing the OLPC parameter determination comprises performing the OLPC parameter determination using an artificial intelligence or machine learning model.

In some aspects, method 1100 further includes receiving a first indication of at least one of (i) a range of selectable values for each of the one or more OLPC parameters or (ii) a set of selectable values for each of the one or more OLPC parameters, wherein determining the one or more OLPC parameters comprises determining an OLPC parameter (i) within the range of selectable values or (ii) from the set of selectable values.

In some aspects, method 1100 further includes receiving the indication of at least the set of selectable values for the one or more OLPC parameters, wherein determining the one or more OLPC parameters comprises determining an OLPC parameter from the set of selectable values, and the set of selectable values includes a plurality of adjustments for an OLPC parameter.

In some aspects, method 1100 further includes receiving the indication of at least the range of selectable values for the one or more OLPC parameters, wherein determining the one or more OLPC parameters comprises determining an OLPC parameter from the range of selectable values, and the range of selectable values includes a plurality of adjustments for an OLPC parameter.

In some aspects, the first indication is associated with a capability of the UE.

In some aspects, method 1100 further includes receiving a second indication which includes at least one of: a reconfiguration of the range of selectable values or the set of selectable values, an activation of the range of selectable values or the set of selectable values, a deactivation of the range of selectable values or the set of selectable values, or a fall back to a configured value for the one or more OLPC parameters.

In some aspects, the second indication is based at least in part on at least one of: an interference level, a throughput, a number of transmitting UEs, or a received power of the communication.

In some aspects, the second indication includes the reconfiguration of the range of selectable values and the method 1100 further comprises determining an updated OLPC parameter according to the reconfiguration of the range of selectable values.

In some aspects, the second indication includes the reconfiguration of the set of selectable values and the method 1100 further comprises determining an updated OLPC parameter according to the reconfiguration of the set of selectable values.

In some aspects, the second indication includes the activation of the range of selectable values and the method 1100 further comprises determining an updated OLPC parameter according to the activation of the range of selectable values.

In some aspects, the second indication includes the activation of the set of selectable values and the method 1100 further comprises determining an updated OLPC parameter according to the activation of the set of selectable values.

In some aspects, the second indication includes the deactivation of the range of selectable values and the method 1100 further comprises determining an updated OLPC parameter according to the deactivation of the range of selectable values.

In some aspects, the second indication includes the deactivation of the set of selectable values and the method 1100 further comprises determining an updated OLPC parameter according to the deactivation of the set of selectable values.

In some aspects, the second indication includes the fall back to the configured value and the method 1100 further comprises determining an updated OLPC parameter according to the configured value.

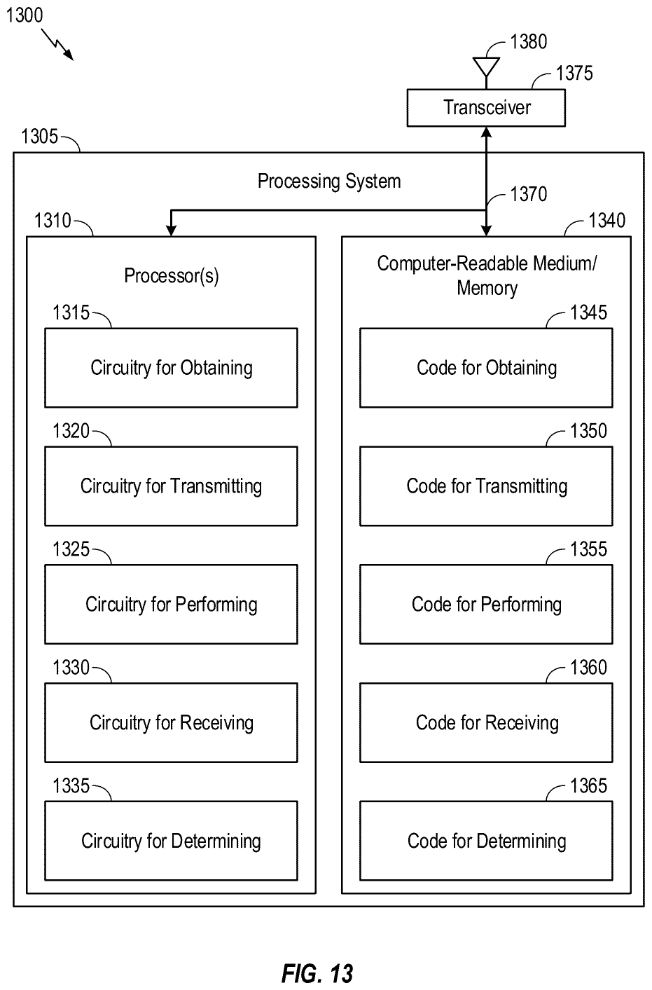

In some aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Operations of a Network Entity

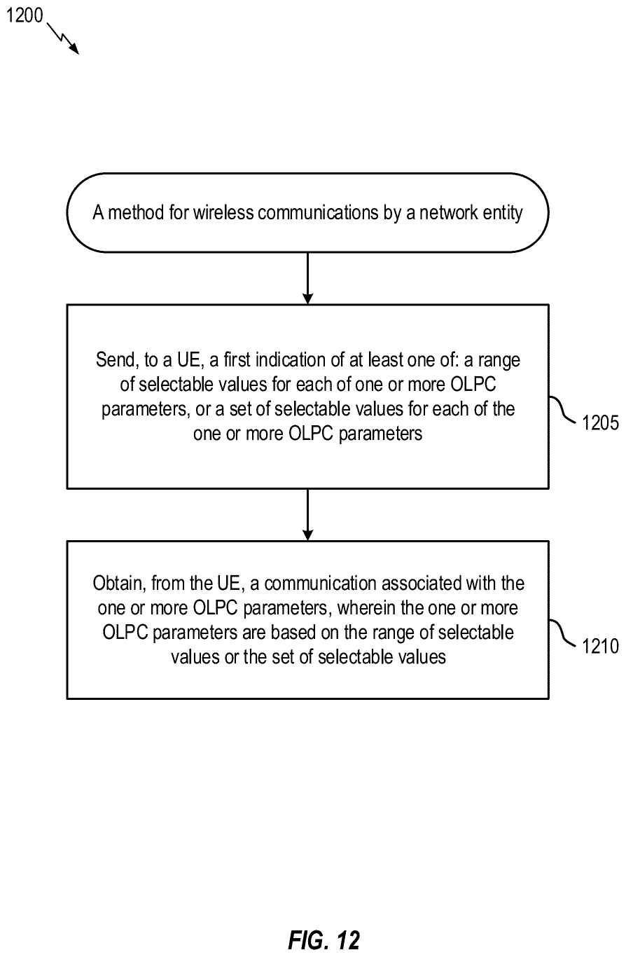

FIG. 12 shows a method 1200 for wireless communications by an apparatus, such as BS 102 of FIG. 1, a first network entity 300 or second network entity 302 of FIG. 3, or a disaggregated base station as discussed with respect to FIG. 2.

Method 1200 begins at block 1205 with sending, to a UE, a first indication of at least one of: a range of selectable values for each of one or more OLPC parameters, or a set of selectable values for each of the one or more OLPC parameters.

Method 1200 then proceeds to block 1210 with obtaining, from the UE, a communication associated with the one or more OLPC parameters, wherein the one or more OLPC parameters are based on the range of selectable values or the set of selectable values.

In some aspects, the one or more OLPC parameters include a target receiving power parameter.

In some aspects, the one or more OLPC parameters include a pathloss parameter.

In some aspects, the one or more OLPC parameters include a scaling factor for a pathloss parameter.

In certain aspects, method 1200 further includes sending the first indication of at least the set of selectable values for the one or more OLPC parameters, wherein the set of selectable values includes a plurality of adjustments for an OLPC parameter.

In certain aspects, method 1200 further includes sending the first indication of at least the range of selectable values for the one or more OLPC parameters, wherein the range of selectable values includes a plurality of adjustments for an OLPC parameter.

In certain aspects, method 1200 further includes receiving information indicating a capability of the UE, wherein the first indication is associated with the capability of the UE.

In certain aspects, method 1200 further includes sending a second indication which includes at least one of: a reconfiguration of the range of selectable values or the set of selectable values, an activation of the range of selectable values or the set of selectable values, a deactivation of the range of selectable values or the set of selectable values, or a fall back to a configured value for the one or more OLPC parameters.

In some aspects, the second indication is based at least in part on at least one of: an interference level, a throughput, a number of transmitting UEs, or a received power of the communication.

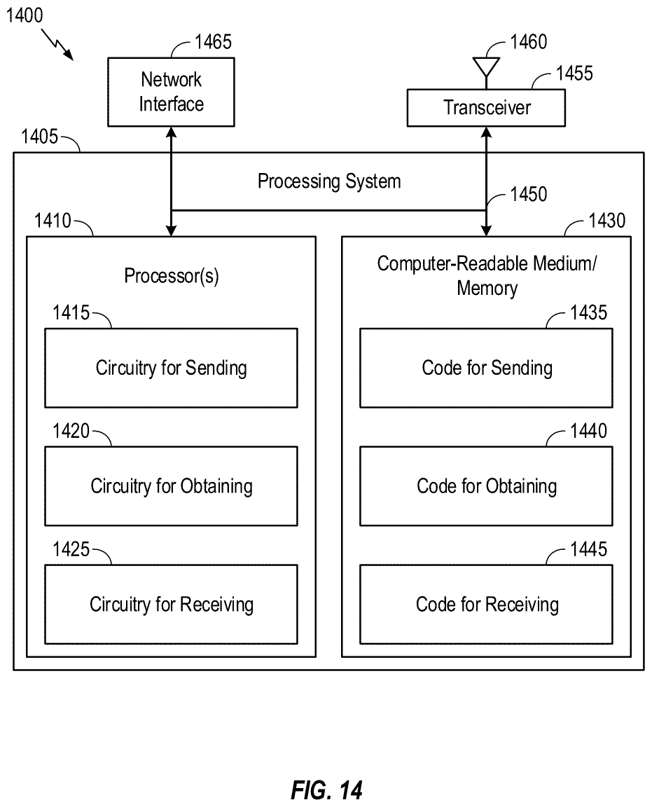

In some aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1375 (e.g., a transmitter and/or a receiver). The transceiver 1375 is configured to transmit and receive signals for the communications device 1300 via an antenna 1380, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1340. In various aspects, the one or more processors 1310 may be representative of the one or more processors 318 described with respect to FIG. 3. The one or more processors 1310 are coupled to a computer-readable medium/memory 1340 via a bus 1370. In some aspects, the computer-readable medium/memory 1340 may be representative of the one or more memories 320 described with respect to FIG. 3. The computer-readable medium/memory 1340 is a non-transitory computer-readable medium/memory. In certain aspects, the computer-readable medium/memory 1340 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1340 stores code (e.g., executable instructions), including code for obtaining 1345, code for transmitting 1350, code for performing 1355, code for receiving 1360, and code for determining 1365. Processing of the code 1345-1365 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1340, including circuitry for obtaining 1315, circuitry for transmitting 1320, circuitry for performing 1325, circuitry for receiving 1330, and circuitry for determining 1335. Processing with circuitry 1315-1335 may enable and cause the communications device 1300 to perform the method 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1375 and/or antenna 1380 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1375 and/or antenna 1380 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, or a disaggregated base station as discussed with respect to FIG. 2.

The communications device 1400 includes a processing system 1405 coupled to a transceiver 1455 (e.g., a transmitter and/or a receiver) and/or a network interface 1465. The transceiver 1455 is configured to transmit and receive signals for the communications device 1400 via an antenna 1460, such as the various signals as described herein. The network interface 1465 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1430. In various aspects, one or more processors 1410 may be representative of the one or more processors 308, as described with respect to FIG. 3. The one or more processors 1410 are coupled to the computer-readable medium/memory 1430 via a bus 1450. In certain aspects, the computer-readable medium/memory 1430 is configured to store instructions (e.g., computer-executable code), including code 1435-1445, that when executed by the one or more processors 1410, cause the one or more processors 1410 to perform the method 1200 described with respect to FIG. 12, or any aspect related to it, including any operations described in relation to FIG. 12. The computer-readable medium/memory 1430 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1430 stores code (e.g., executable instructions), including code for sending 1435, code for obtaining 1440, and code for receiving 1445. Processing of the code 1435-1445 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1430, including circuitry for sending 1415, circuitry for obtaining 1420, and circuitry for receiving 1425. Processing with circuitry 1415-1425 may enable and cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1455, antenna 1460, and/or network interface 1465 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1455, antenna 1460, and/or network interface 1465 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by a UE comprising: obtaining a set of input parameters associated with an OLPC parameter determination; and transmitting a communication using one or more OLPC parameters, wherein the one or more OLPC parameters are based on the set of input parameters and the OLPC parameter determination, and wherein the one or more OLPC parameters are associated with at least one of a quality of service or an energy allocation.

Clause 2: The method of Clause 1, wherein the one or more OLPC parameters are associated with the quality of service based on at least one of: a reliability parameter associated with the communication, a latency parameter associated with the communication, or a priority parameter associated with the communication.

Clause 3: The method of any one of Clauses 1-2, wherein the one or more OLPC parameters are associated with the energy allocation based on at least one of: an energy budget associated with the communication, or an energy allocation associated with the communication.

Clause 4: The method of any one of Clauses 1-3, wherein the set of input parameters includes one or more input parameters associated with a radio link status.

Clause 5: The method of any one of Clauses 1-4, wherein the set of input parameters includes one or more input parameters associated with a physical environment of the UE.

Clause 6: The method of any one of Clauses 1-5, wherein the set of input parameters includes one or more input parameters associated with a characteristic of data traffic.

Clause 7: The method of any one of Clauses 1-6, wherein the set of input parameters includes one or more input parameters associated with UE information of the UE.

Clause 8: The method of any one of Clauses 1-7, wherein the set of input parameters includes one or more input parameters associated with an artificial intelligence or machine learning model.

Clause 9: The method of any one of Clauses 1-8, wherein the one or more OLPC parameters include a target receiving power parameter.

Clause 10: The method of any one of Clauses 1-9, wherein the one or more OLPC parameters include a pathloss parameter.

Clause 11: The method of any one of Clauses 1-10, wherein the one or more OLPC parameters include a scaling factor for a pathloss parameter.

Clause 12: The method of any one of Clauses 1-11, further comprising performing the OLPC parameter determination to determine the one or more OLPC parameters based on the set of input parameters.

Clause 13: The method of Clause 12, wherein performing the OLPC parameter determination comprises performing the OLPC parameter determination using an artificial intelligence or machine learning model.

Clause 14: The method of Clause 12, further comprising receiving a first indication of at least one of (i) a range of selectable values for each of the one or more OLPC parameters or (ii) a set of selectable values for each of the one or more OLPC parameters, wherein determining the one or more OLPC parameters comprises determining an OLPC parameter (i) within the range of selectable values or (ii) from the set of selectable values.

Clause 15: The method of Clause 14, further comprising: receiving the indication of at least the set of selectable values for the one or more OLPC parameters; wherein determining the one or more OLPC parameters comprises determining an OLPC parameter from the set of selectable values, and the set of selectable values includes a plurality of adjustments for an OLPC parameter.

Clause 16: The method of Clause 14, further comprising receiving the indication of at least the range of selectable values for the one or more OLPC parameters; wherein determining the one or more OLPC parameters comprises determining an OLPC parameter from the range of selectable values, and the range of selectable values includes a plurality of adjustments for an OLPC parameter.

Clause 17: The method of Clause 14, wherein the first indication is associated with a capability of the UE.

Clause 18: The method of Clause 14, further comprising receiving a second indication which includes at least one of: a reconfiguration of the range of selectable values or the set of selectable values, an activation of the range of selectable values or the set of selectable values, a deactivation of the range of selectable values or the set of selectable values, or a fall back to a configured value for the one or more OLPC parameters.

Clause 19: The method of Clause 18, wherein the second indication is based at least in part on at least one of: an interference level, a throughput, a number of transmitting UEs, or a received power of the communication.

Clause 20: The method of Clause 18, wherein the second indication includes the reconfiguration of the range of selectable values and the method further comprises determining an updated OLPC parameter according to the reconfiguration of the range of selectable values.

Clause 21: The method of Clause 18, wherein the second indication includes the reconfiguration of the set of selectable values and the method further comprises determining an updated OLPC parameter according to the reconfiguration of the set of selectable values.

Clause 22: The method of Clause 18, wherein the second indication includes the activation of the range of selectable values and the method further comprises determining an updated OLPC parameter according to the activation of the range of selectable values.

Clause 23: The method of Clause 18, wherein the second indication includes the activation of the set of selectable values and the method further comprises determining an updated OLPC parameter according to the activation of the set of selectable values.

Clause 24: The method of Clause 18, wherein the second indication includes the deactivation of the range of selectable values and the method further comprises determining an updated OLPC parameter according to the deactivation of the range of selectable values.

Clause 25: The method of Clause 18, wherein the second indication includes the deactivation of the set of selectable values and the method further comprises determining an updated OLPC parameter according to the deactivation of the set of selectable values.

Clause 26: The method of Clause 18, wherein the second indication includes the fall back to the configured value and the method further comprises determining an updated OLPC parameter according to the configured value.

Clause 27: A method for wireless communications by a network entity comprising: sending, to a UE, a first indication of at least one of: a range of selectable values for each of one or more OLPC parameters, or a set of selectable values for each of the one or more OLPC parameters; and obtaining, from the UE, a communication associated with the one or more OLPC parameters, wherein the one or more OLPC parameters are based on the range of selectable values or the set of selectable values.

Clause 28: The method of Clause 27, wherein the one or more OLPC parameters include a target receiving power parameter.

Clause 29: The method of any one of Clauses 27-28, wherein the one or more OLPC parameters include a pathloss parameter.

Clause 30: The method of any one of Clauses 27-29, wherein the one or more OLPC parameters include a scaling factor for a pathloss parameter.

Clause 31: The method of any one of Clauses 27-30, further comprising sending the first indication of at least the set of selectable values for the one or more OLPC parameters, wherein the set of selectable values includes a plurality of adjustments for an OLPC parameter.

Clause 32: The method of any one of Clauses 27-31, further comprising sending the first indication of at least the range of selectable values for the one or more OLPC parameters, wherein the range of selectable values includes a plurality of adjustments for an OLPC parameter.

Clause 33: The method of any one of Clauses 27-32, further comprising receiving information indicating a capability of the UE, wherein the first indication is associated with the capability of the UE.

Clause 34: The method of any one of Clauses 27-33, further comprising sending a second indication which includes at least one of: a reconfiguration of the range of selectable values or the set of selectable values, an activation of the range of selectable values or the set of selectable values, a deactivation of the range of selectable values or the set of selectable values, or a fall back to a configured value for the one or more OLPC parameters.

Clause 35: The method of Clause 34, wherein the second indication is based at least in part on at least one of: an interference level, a throughput, a number of transmitting UEs, or a received power of the communication.

Clause 36: One or more apparatuses, comprising: one or more memories comprising executable instructions; and one or more processors configured to execute the executable instructions and cause the one or more apparatuses to perform a method in accordance with any one of Clauses 1-35.

Clause 37: One or more apparatuses configured for wireless communications, comprising: one or more memories; and one or more processors, coupled to the one or more memories, configured to cause the one or more apparatuses to perform a method in accordance with any one of Clauses 1-35.

Clause 38: One or more apparatuses configured for wireless communications, comprising: one or more memories; and one or more processors, coupled to the one or more memories, configured to perform a method in accordance with any one of Clauses 1-35.

Clause 39: One or more apparatuses, comprising means for performing a method in accordance with any one of Clauses 1-35.

Clause 40: One or more non-transitory computer-readable media comprising executable instructions that, when executed by one or more processors of one or more apparatuses, cause the one or more apparatuses to perform a method in accordance with any one of Clauses 1-35.

Clause 41: One or more computer program products embodied on one or more computer-readable storage media comprising code for performing a method in accordance with any one of Clauses 1-35.

Clause 42: One or more apparatuses configured for wireless communications, comprising: a processing system that includes one or more processors and one or more memories coupled with the one or more processors, the processing system configured to cause the one or more apparatuses to perform a method in accordance with any one of Clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain a set of input parameters associated with an open-loop power control (OLPC) parameter determination; and
transmit a communication using one or more OLPC parameters, wherein the one or more OLPC parameters are based on the set of input parameters and the OLPC parameter determination, and wherein the one or more OLPC parameters are associated with at least one of a quality of service or an energy allocation.

2. The apparatus of claim 1, wherein the one or more OLPC parameters are associated with the quality of service based on at least one of:
a reliability parameter associated with the communication,
a latency parameter associated with the communication, or
a priority parameter associated with the communication.

3. The apparatus of claim 1, wherein the one or more OLPC parameters are associated with the energy allocation based on at least one of:
an energy budget associated with the communication, or
an energy allocation associated with the communication.

4. The apparatus of claim 1, wherein the set of input parameters includes one or more input parameters associated with a radio link status.

5. The apparatus of claim 1, wherein the set of input parameters includes one or more input parameters associated with a physical environment of the UE.

6. The apparatus of claim 1, wherein the set of input parameters includes one or more input parameters associated with a characteristic of data traffic.

7. The apparatus of claim 1, wherein the set of input parameters includes one or more input parameters associated with UE information of the UE.

8. The apparatus of claim 1, wherein the set of input parameters includes one or more input parameters associated with an artificial intelligence or machine learning model.

9. The apparatus of claim 1, wherein the one or more OLPC parameters include a target receiving power parameter.

10. The apparatus of claim 1, wherein the one or more OLPC parameters include a pathloss parameter.

11. The apparatus of claim 1, wherein the one or more OLPC parameters include a scaling factor for a pathloss parameter.

12. The apparatus of claim 1, wherein the processing system is configured to cause the UE to perform the OLPC parameter determination to determine the one or more OLPC parameters based on the set of input parameters.

13. The apparatus of claim 12, wherein to cause the UE to perform the OLPC parameter determination, the processing system is configured to cause the UE to perform the OLPC parameter determination using an artificial intelligence or machine learning model.

14. The apparatus of claim 12, wherein the processing system is configured to cause the UE to receive a first indication of at least one of (i) a range of selectable values for each of the one or more OLPC parameters or (ii) a set of selectable values for each of the one or more OLPC parameters, wherein to cause the UE to determine the one or more OLPC parameters, the processing system is configured to cause the UE to determine an OLPC parameter (i) within the range of selectable values or (ii) from the set of selectable values.

15. The apparatus of claim 14, wherein the processing system is configured to cause the UE to receive the indication of at least the set of selectable values for the one or more OLPC parameters, wherein to cause the UE to determine the one or more OLPC parameters, the processing system is configured to cause the UE to determine an OLPC parameter from the set of selectable values, and wherein the set of selectable values includes a plurality of adjustments for an OLPC parameter.

16. The apparatus of claim 14, wherein the processing system is configured to cause the UE to receive the indication of at least the range of selectable values for the one or more OLPC parameters, wherein to cause the UE to determine the one or more OLPC parameters, the processing system is configured to cause the UE to determine an OLPC parameter from the range of selectable values, and wherein the range of selectable values includes a plurality of adjustments for an OLPC parameter.

17. The apparatus of claim 14, wherein the first indication is associated with a capability of the UE.

18. The apparatus of claim 14, wherein the processing system is configured to cause the UE to receive a second indication which includes at least one of:
a reconfiguration of the range of selectable values or the set of selectable values,
an activation of the range of selectable values or the set of selectable values,
a deactivation of the range of selectable values or the set of selectable values, or
a fall back to a configured value for the one or more OLPC parameters.

19. The apparatus of claim 18, wherein the second indication is based at least in part on at least one of:
an interference level,
a throughput,
a number of transmitting UEs, or
a received power of the communication.

20. The apparatus of claim 18, wherein the second indication includes the reconfiguration of the range of selectable values and the processing system is configured to cause the UE to determine an updated OLPC parameter according to the reconfiguration of the range of selectable values.

21. The apparatus of claim 18, wherein the second indication includes the reconfiguration of the set of selectable values and the processing system is configured to cause the UE to determine an updated OLPC parameter according to the reconfiguration of the set of selectable values.

22. The apparatus of claim 18, wherein the second indication includes the activation of the range of selectable values and the processing system is configured to cause the UE to determine an updated OLPC parameter according to the activation of the range of selectable values.

23. An apparatus for wireless communications, comprising a processing system that includes one or more processors and one or more memories coupled with the one or more processors, the processing system configured to cause a network entity to:
send, to a user equipment (UE), a first indication of at least one of: a range of selectable values for each of one or more open-loop power control (OLPC) parameters, or a set of selectable values for each of the one or more OLPC parameters; and
obtain, from the UE, a communication associated with the one or more OLPC parameters, wherein the one or more OLPC parameters are based on the range of selectable values or the set of selectable values.

24. The apparatus of claim 23, wherein the processing system is configured to cause the network entity to send the first indication of at least the set of selectable values for the one or more OLPC parameters, wherein the set of selectable values includes a plurality of adjustments for an OLPC parameter.

25. The apparatus of claim 23, wherein the processing system is configured to cause the network entity to send the first indication of at least the range of selectable values for the one or more OLPC parameters, wherein the range of selectable values includes a plurality of adjustments for an OLPC parameter.

26. The apparatus of claim 23, wherein the processing system is configured to cause the network entity to receive information indicating a capability of the UE, wherein the first indication is associated with the capability of the UE.

27. The apparatus of claim 23, wherein the processing system is configured to cause the network entity to send a second indication which includes at least one of:
a reconfiguration of the range of selectable values or the set of selectable values,
an activation of the range of selectable values or the set of selectable values,
a deactivation of the range of selectable values or the set of selectable values, or
a fall back to a configured value for the one or more OLPC parameters.

28. The apparatus of claim 27, wherein the second indication is based at least in part on at least one of:
an interference level,
a throughput,
a number of transmitting UEs, or
a received power of the communication.

29. A method for wireless communications by a user equipment (UE) comprising:
obtaining a set of input parameters associated with an open-loop power control (OLPC) parameter determination; and
transmitting a communication using one or more OLPC parameters, wherein the one or more OLPC parameters are based on the set of input parameters and the OLPC parameter determination, and wherein the one or more OLPC parameters are associated with at least one of a quality of service or an energy allocation.

30. A method for wireless communications by a network entity comprising:
sending, to a user equipment (UE), a first indication of at least one of: a range of selectable values for each of one or more open-loop power control (OLPC) parameters, or a set of selectable values for each of the one or more OLPC parameters
obtaining, from the UE, a communication associated with the one or more OLPC parameters, wherein the one or more OLPC parameters are based on the range of selectable values or the set of selectable values.
